(19) United States
(12) Patent Application Publication
(10) Pub. No.: US 2008/0281776 A1
(43) Pub. Date: Nov. 13, 2008

(54) Interactive System For Creating, Organising, and Sharing One's Own Databank of Pictures Such as Photographs, Drawings, Art, Sketch, Iconography, Illustrations, Portraits, Paintings and Images

(76) Inventor: Gautam Dharamdas Goradia, Maharashtra (IN)

Correspondence Address: INTELLECTUAL PROPERTY LAW GROUP LLP, 12 SOUTH FIRST STREET, SUITE 1205, SAN JOSE, CA, 95113, US

(21) Appl. No.: 10/598,542

(22) PCT Filed: Feb. 18, 2005
(86) PCT No.: PCT/IN05/00051

§ 371 Date: Sep. 1, 2006

(30) Foreign Application Priority Data
Mar. 3, 2004 (IN) 253/MUM/2004

(51) Int. Cl. G06F 17/30

(52) U.S. Cl. 707/2; 707/E17.002

(57) ABSTRACT

An interactive system for creating, organising, and sharing one's own databank of pictures is disclosed, it being accepted that one may want to build such data based on one's personal interest, by well-defined classifications, using a computer system comprising of; a. (i) a User Interface; (ii). a Database comprising a. a Picture Bank Database; b. a User Database; c. a Configuration Database; (iii) At least one data input, organising and management module(s) allowing a user to input, append, and modify well-classified data (iv) Module allowing a user to invoke a Picture Session; (v) Module allowing a user to Schedule data; (vi) Module allowing the user to Export data from the Database(s); (vii) Module allowing the user to Import data; (viii) Module allowing the user to use the data in the Database as a screen saver.

### FIELD OF INVENTION

The present invention relates to an interactive System for building (including saving, appending, retrieving, modifying), organising, and sharing one's own databank of Pictures such as Photographs, Drawings, Art, Sketch, Iconography, Illustrations, Portraits, Paintings, Images and such others, it being accepted that one may want to create (including saving, appending, retrieving, modifying), store, and organise such data based on one's personal interest by well-defined classifications like Source of Information, Type of Picture, Creator of Picture, Category and Sub Category; store additional information such as Location, and Remarks; use such data to, inter alia, enjoy by taking Picture Sessions, Attach Image, Animation and/or Sound files to the same, Associate more information in the form of Files, URLs, Remarks to the same, Schedule such data, Print data, as well as obtain a plurality of Reports; share such data.

### BACKGROUND OF THE INVENTION

It is a well-accepted fact that Pictures in any form such as photographs, drawings, art, sketch, iconography, illustrations, portraits, paintings, and images and such others are an integral part of daily life.

It is generally known that people like to take photographs of people, objects, places, and events for the purpose of recollecting the same. Especially in case of a family or a group, it is commonplace to take photographs commemorating special occasions such as birthdays, weddings, and the like. Moreover, in case of some families, photographs and/or portraits of ancestors and previous generations are preserved with meticulous care.

It is also a well-accepted fact that photographs and illustrations of important historical events, people, objects and places serve to keep the past alive in public memory.

It is also a well-accepted fact that people create or store Pictures of nature, landscapes, people, and the like, for personal or professional interests, such Pictures being unique and proprietary to the creators. It is also a well-accepted fact that such people often review and edit their work several times. It would be useful for such people to be able to store, edit and display such Pictures, as well as to share the same with others.

It is a well-accepted fact that some people, right from childhood, are gifted with an inborn trait to create brilliant works of art in the form of sketches, paintings, portraits, illustrations, and the like. Further, it is also known that most children in their early years of education, study drawing, sketching, and/or painting as a subject. It has been observed that these children take a certain period of time to completely learn and master the techniques of good drawing, sketching, and/or painting. As such, it would be very helpful if there were a tool that would store their drawings, sketches, and/or paintings and thus help monitor the progress made by these children in terms of the quality of the same. Further, some people feel a sense of nostalgia about their formative years by storing such drawings, sketches, and/or paintings.

It is a well-accepted fact that there are people who are connoisseurs of works of art, and who spend huge amounts in acquiring and storing the same.

It is a well-accepted fact that with the advent of technology, there have been several advancements in the field of arts. People nowadays make extensive use of computer systems to create and store various art forms such as paintings, portraits, designs, and such others.

It is often said that a Picture is worth a thousand words, and this is especially relevant in the modern age of technology. The human mind responds more quickly to Pictures, and hence they play an important role in communicating information through various media such as Print, Television, and the Internet. For example, in a newspaper, a news article when accompanied by a suitable Picture gives the reader a clearer insight and provides for better understanding of the same. Further, many newspapers, online as well as offline, have sections wherein news articles are depicted through a series of Pictures.

It is a well-accepted fact that in the field of education, a drawing or an illustration of an object, concept or theory (either concrete or abstract in nature) enables greater understanding of the same and thus enriches the learning process.

It is a well-accepted that people nowadays use digital cameras to take photographs, and as such, there is a growing need for storing and organizing such photographs in a well-classified manner. It has been observed that currently the systems available for organizing such photographs provide only a minimal set of classifications.

It is a well-accepted fact that there are many companies which create, store and maintain a repository of Pictures, whether offline or online, in the form of Picture libraries for commercial purposes. A typical Picture library may contain millions of Pictures and as such, its primary objective is to enable a user to find a Picture quickly and easily. It has been generally observed that the Pictures in a Picture library are not well-classified and as such finding them becomes a tedious process.

It is a well-accepted fact that Pictures play a crucial role in authenticating information about a person's identity. For example, many organizations, whether commercial or otherwise, make it mandatory that the persons working for them should possess ID cards or some sort of identification which requires a personal photograph. Further, it is also well known that sketches and illustrations of criminals and suspicious persons, help the police and other intelligence agencies to track them down easily.

It is a well-accepted fact that most Systems available today, organize Pictures that reside as files on the hard disk or any similar storage device of a computer system. However, when there are too many files and folders, it would be very difficult to manage them effectively, share them with ease, make changes across several files, index the same with ease, and use a plurality of conditions to search the same. Moreover, it is a well-accepted fact that information stored in a well-classified database, with meaningful classifications, can be utilized very effectively.

It is a well-accepted fact that people generally cannot manage a large amount of data whether by classifications or not, without external help, and it would be very helpful if there were to exist a System that would help people to Add, Retrieve, Modify, Delete, Print, Export, and Import such data, thereby helping people to manage such data for use in daily life, for the purpose of entertainment and enjoyment.

### US2002180764 Method and System for Digital Image Management

Method and system for converting a plurality of digital images having different attributes to a common, selected/preset set of attributes, and for transferring them to a centralized storage unit are disclosed. Initially, the source locations of the digital images are identified. Next, the desired image attributes such as size, aspect ratio, color depth, and compression format for the digital images are selected. The digital images are then converted from their original attributes to the selected/preset attributes. The converted images are thereafter uploaded to the centralized storage unit where they may be stored and subsequently downloaded to one or more different users.

### TW589869 Intelligent Image Data Storage Management Method and the Device Thereof

The present invention provides a method for intelligent image data storage management, which includes the basic steps: providing a storage medium, including at least one image data, wherein the image data includes a base layer and an enhancement layer; the enhancement layer comprising the image data layer with a plurality of image quality coefficients; adding one image data; deleting part of the image quality coefficients of the enhancement layer; and, obtaining a new storage space from the storage medium, wherein the capacity of the new storage space is larger than or equal to the capacity of the new image data for storing the new image data.

U.S. Pat. No. 6,332,146 Method and Apparatus for Storing and Printing Digital Images

A digital data management and order delivery system is provided. The system includes a storage device for storing digital data and a searching engine for developing a subset of the digital data stored in the storage device in response to inputs received from a first user. The system is also provided with a job order developer responsive to inputs received from the first user for developing a job order which includes: a) at least one copy of the digital data contained in the subset and identified by the first user; and b) a file containing information developed by the first user outside the system. In addition, the system includes a router for electronically routing the job order compiled by the job order developer to a second user specified by the first user.

### US2004135894 Method, Apparatus and Program for Image Classification

Image data sets are enabled to be classified for each of a plurality of people, who share a device that stores image data sets, such as a digital camera. Date data that represent a photography date are attached to image data sets. A database stores therein events related to each of the plurality of people, correlated with the dates of the events. The image data sets are correlated with events related to each person by referring to the database. For example, the database stores therein events related to family members (Father, Mother, and Son), correlated with the dates of the events. Accordingly, events are selected from the database based on the date data attached to the image data sets, and the image data sets are correlated with the selected events. Thereby, image data sets are enabled to be classified according to events for each person.

### US2003184586 Illustration Creating Program

Provided is an illustration creating program which can be easily used even by a first-time user. When the program is started, a menu bar, a toolbox, a preview window and setting windows are displayed on a display. When a submenu item “New” is selected from a main menu item “File” of the menu bar, a drawing window is displayed on the screen. Thus, the toolbox, the preview window, a paintbrush information setting window capable of setting a tool, a color setting window, a color palette setting window, a control setting window, a layer setting window capable of setting the drawing window, and a selected-range setting window are displayed on the screen.

The prior art systems described in the foregoing descriptions have an inherent limitation, in that, they do not allow the user to create, organise, sufficiently enjoy, and share their own databank of Pictures such as photographs, drawings, art, sketch, iconography, illustrations, portraits, paintings, and images.

Therefore, by dint of determined research and intuitive knowledge, our inventor has developed an interactive System that enables users to create (including saving, appending, retrieving, modifying), organise, and share their own databank of Pictures by well-defined Classifications, and which further enables users to enjoy Pictures by means of Picture Sessions and Scheduled displays, and which further enables users to export data to other users of this System, and which further allows users to import data.

### SUMMARY OF THE INVENTION

An object of the present invention is to allow the user to create, organise, and share one's own databank of Pictures such as Photographs, Drawings, Art, Sketch, Iconography, Illustrations, Portraits, Paintings, and Images, it being accepted that one may want to create (including saving, appending, retrieving, modifying) and organise such data, based on one's personal interest and further store it by well-defined classifications like Source of Information, Type of Picture, Creator of Picture, Category and Sub Category, such classification of data not restricted to any already provided data.

Yet another object of the present invention is to maintain a history of the records viewed by the user in such a databank of Pictures.

Yet another object of the present invention is to allow users to FIND data rapidly and efficiently by none or one or more FIND conditions, wherein the FIND conditions to find the Pictures from the Database(s) are defined by none or one or more Criteria like the Date, Record ID, Source of Information, Type of Picture, Creator of Picture, Category and Sub Category, as well as by keywords, wildcard characters, by whether or not a Picture has File Attachments/Associations and/or Attachment/Association Remarks, Import Remarks, and/or whether or not a Record has been Bookmarked and further by Bookmark Remarks, and/or whether or not a Picture is marked as “Private” or “Public” and/or “Favourite” as well as assigned a Rating, and/or by whether or not a Picture has been used in a Picture/Scheduled Session and if so, the number of times it has been used. The user can exercise the option of using the above conditions to bring forth or avoid Pictures by the specified conditions.

Yet another object of the present invention is to allow the user to add Bookmark Remarks, Attachments, Associations of Files, including Media files, URLs and more Remarks and further Attachment/Association Remarks to the Pictures.

Yet another object of the present invention is to allow users to mark Pictures as “Public” or “Private”, individually or globally, and assign the same to specific users or user groups.

Yet another object of the present invention is to allow users to mark selected Pictures as “Favourite”, individually or globally, and assign the same to specific users or user groups.

Yet another object of the present invention is to allow users to assign a Rating to the Pictures, individually or globally, and assign the same to specific users or user groups.

Yet another object of the present invention is to allow users to Navigate efficiently between the Records.

Yet another object of the present invention is to allow users to Modify Pictures individually and globally, and further selectively.

Yet another object of the present invention is to allow users to share Pictures created and/or stored by the users using the Export/Import/Print utilities, such Exporting/Importing/Printing of data capable of being done selectively.

Yet another object of the present invention is to allow users to delete the Pictures, individually or globally, sending the deleted Pictures to the Recycle Bin of the System, and further restoring or deleting the same, singularly or plurally.

Yet another object of the present invention is to allow users to take Picture Session(s) using the Pictures stored in the Database(s), by finding the same by none or one or more FIND conditions.

Yet another object of the present invention is to allow the user to Schedule Pictures, and/or Schedule Picture Sessions by finding the same based on none or one or more FIND conditions, to be brought up on the user's computer system at preset time intervals.

Yet another object of the present invention is to provide various Reports selectively and having the further utility of customising the same.

Yet another object of the present invention is to provide the necessary Tools to the user for better customisation and maintenance of the System in various ways.

Yet another object of the present invention is to provide a utility for creating, modifying, deleting, printing, navigating, finding Masters like Source of Information, Type of Picture, Creator of Picture, Category and Sub Category, with sufficient security so as not to allow the deletion of any Master of a Record that may be in use.

Yet another object of the present invention is to allow the user to Print any Picture of the user's choice as well as obtain a plurality of Reports.

Yet another object of the present invention is to allow users to use the Pictures stored in the Database(s) as a screen saver.

Yet another object of the present invention is to allow the users to set the Pictures stored in the Database(s) as desktop wallpapers.

Yet another object of the present invention is to allow the users to view the Pictures stored in the Database(s) in the form of thumbnails.

Yet another object of the present invention is to allow one or more module(s)/utility(s) to operate within a browser and/or other viewing and/or processing programs.

These and other embodiments of the present invention are further made apparent, in the remainder of the present document, to those of ordinary skill in the art.

### BRIEF DESCRIPTION OF THE DRAWINGS

To complement the description that is being given and in order to promote a better understanding of the characteristics of the invention in accordance with a practical embodiment of the same and as an integral part of the said description a set of drawings accompany it in which the following are represented in an illustrative and non-restrictive way. These drawings are not to be considered limitations in the scope of the invention, but are merely illustrative.

FIG. 1 is the diagram of the System block according to an embodiment of the present invention.

FIG. 2 is the diagram of the Multiple User System according to an embodiment of the present invention

FIG. 3 is the diagram of the Outline of the System Process according to an embodiment of the present invention

FIG. 4 is the diagram of the System Function of the Picture Bank Module according to an embodiment of the present invention

FIG. 5 is the diagram of the System Operation of the Picture Bank Module according to an embodiment of the present invention

FIG. 6 is the diagram of the System State Transition of the Picture Bank Module according to an embodiment of the present invention

FIG. 7 is the diagram of the System Function of the Global Changes Module according to an embodiment of the present invention

FIG. 8 is the diagram of the System Operation of the Global Changes Module according to an embodiment of the present invention

FIG. 9 is the diagram of the System State Transition of the Global Changes Module according to an embodiment of the present invention

FIG. 10 is the diagram of the System Function of the Picture Session Module according to an embodiment of the present invention

FIG. 11 is the diagram of the System Operation of the Picture Session Module according to an embodiment of the present invention

FIG. 12 is the diagram of the System State Transition of the Picture Session Module according to an embodiment of the present invention

FIG. 13 is the diagram of the System Function of the Reports Module according to an embodiment of the present invention

FIG. 14 is the diagram of the System Operation of the Reports Module according to an embodiment of the present invention

FIG. 15 is the diagram of the System State Transition of the Reports Module according to an embodiment of the present invention

FIG. 16 is the diagram of the System Function of the Export Module according to an embodiment of the present invention

FIG. 17 is the diagram of the System Operation of the Export Module according to an embodiment of the present invention

FIG. 18 is the diagram of the System State Transition of the Export Module according to an embodiment of the present invention

FIG. 19 is the diagram of the System Function of the Import Module according to an embodiment of the present invention

FIG. 20 is the diagram of the System Operation of the Import Module according to an embodiment of the present invention

FIG. 21 is the diagram of the System State Transition of the Import Module according to an embodiment of the present invention

FIG. 22 is the diagram of the System Function of the Picture Scheduler Module according to an embodiment of the present invention

FIG. 23 is the diagram of the System Operation of the Picture Scheduler Module according to an embodiment of the present invention

FIG. 24 is the diagram of the System State Transition of the Picture Scheduler Module according to an embodiment of the present invention

FIG. 25 is the diagram of the System Function of the Screen Saver Module according to an embodiment of the present invention

FIG. 26 is the diagram of the System Operation of the Screen Saver Module according to an embodiment of the present invention

FIG. 27 is the diagram of the System State Transition of the Screen Saver Module according to an embodiment of the present invention

FIG. 28 is the diagram of the System Function of the Recycle Bin Module according to an embodiment of the present invention

FIG. 29 is the diagram of the System Operation of the Recycle Bin Module according to an embodiment of the present invention

FIG. 30 is the diagram of the System State Transition of the Recycle Bin Module according to an embodiment of the present invention

FIG. 31 is the diagram of the System Function of the Tools/Help Menu Options Module according to an embodiment of the present invention

FIG. 32 is the diagram of the System Operation of the Tools/Help Menu Options Module according to an embodiment of the present invention

FIG. 33 is the diagram of the System State Transition of the Tools/Help Menu Options Module according to an embodiment of the present invention

FIG. 34 is the diagram of the System Function of the Master Module according to an embodiment of the present invention

FIG. 35 is the diagram of the System Operation of the Master Module according to an embodiment of the present invention

FIG. 36 is the diagram of the System State Transition of the Master Module according to an embodiment of the present invention

### DETAILED DESCRIPTION OF SPECIFIC EMBODIMENTS

A detailed description of the preferred embodiments and best modes for practicing the present invention are described herein. The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

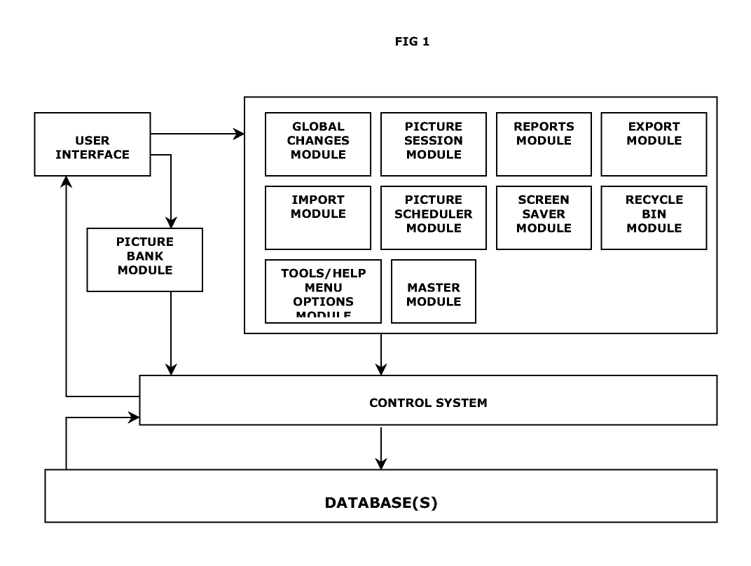

An interactive System for creating (including saving, appending, retrieving, modifying), organising, and sharing one's own databank of Pictures such as Photographs, Drawings, Art, Sketch, Iconography, Illustrations, Portraits, Paintings, Images and such others, wherein FIG. 1 is the diagram of the System Block consisting of different functional blocks and their interaction of the present invention. The User Interface(s) render the user's actions, and with the help of the Control System transmits the appropriate requests to the Database(s). The Control System acts as the bridge between the User Interface(s) and the Database(s).

The Database(s) consists of Picture Bank Database, User Database, and the Configuration Database. Picture Bank Database is the reservoir of an extensible collection of well-classified data and further stores the data user wise. The User Database is the reservoir of the user information and also contains the history of past user interaction with the System. The Configuration Database is the reservoir of the options used for the Customization of the System.

If the user requests for the Picture Bank Module through the User Interface, then the Control System asks the Database Management System to find the corresponding data from the Database(s), resulting in the display of the relevant data, if available. The user then interacts further with the Picture Bank Module through the User Interface with respect to the utilities available in this Module.

If the user requests for the Global Changes Module through the User Interface, then the Control System asks the Database Management System to find the corresponding data from the Database(s), resulting in the display of the data, if available. The user then interacts further with the Global Changes Module through the User Interface with respect to the utilities available in this Module.

If the user requests for the Picture Session Module through the User Interface then the Control System asks the Database Management System to find the corresponding data from the Database(s), resulting in the display of the data, if available. The user then interacts further with the Picture Session Module through the User Interface with respect to the utilities available in this Module.

If the user requests for the Reports Module through the User Interface, then the Control System asks the Database Management System to find the corresponding data from the Database(s), resulting in the display of the relevant data, if available. The user then interacts further with the Reports Module through the User Interface with respect to the utilities available in this Module.

If the user requests for the Export Module through the User Interface, then the Control System asks the Database Management System to find the corresponding data from the Database(s), resulting in the display of the relevant data, if available. The user then interacts further with the Export Module through the User Interface with respect to the utilities available in this Module.

If the user requests for the Import Module through the User Interface, then the Control System asks the Database Management System to retrieve the corresponding data from a valid database file resulting in the display of the relevant data, if available. The user then interacts further with the Import Module through the User Interface with respect to the utilities available in this Module.

If the user requests for the Picture Scheduler Module through the User Interface, then the Control System asks the Database Management System to find the corresponding data from the Database(s), resulting in the display of the data, if available. The user then interacts further with the Picture Scheduler Module through the User Interface with respect to the utilities available in this Module.

If the user requests for the Screen Saver Module through the User Interface, then the Control System asks the Database Management System to find the corresponding data from the Database(s) and retrieves the corresponding data resulting in the display of the data, if available. The user then interacts further with the Screen Saver Module of the System through the User Interface with respect to the utilities available in this Module.

If the user requests for the Recycle Bin Module through the User Interface, then the Control System asks the Database Management System to find the corresponding data from the Database(s) resulting in the display of the relevant data, if available. The user then interacts further with the Recycle Bin Module through the User Interface with respect to the utilities available in this Module.

If the user requests for the Tools/Help Menu Options Module through the User Interface, then the Control System asks the Database Management System to retrieve the corresponding Options available from the Database(s). The user then interacts further with the Tools/Help Menu Options Module through the User Interface with respect to the utilities available in this Module.

If the user requests for the Master Module through the User Interface, then the Control System asks the Database Management System to find the corresponding data from the Database(s) resulting in the display of the relevant data, if available. The user then interacts further with the Master Module through the User Interface with respect to the utilities available in this Module.

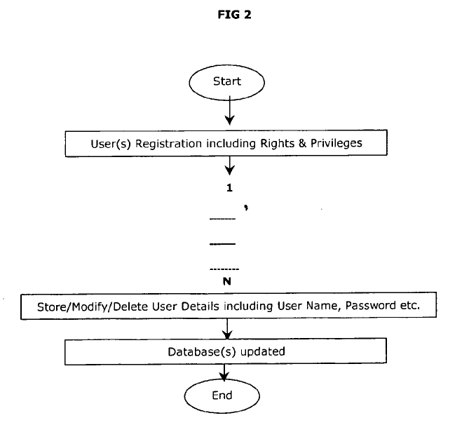

FIG. 2 is the diagram of the Multiple User System of the present invention. It explains that multiple users can use the System at the same time, and also explains that the System can be controlled by rights and privileges. It further allows the user to Store/Modify/Delete the User Details including User Name, Password etc. in the Database(s). Whenever a user wishes to log in to the System, the user has to provide a User Name and password. The user can further modify an existing password. Further, there is also a utility which allows the creation of new users.

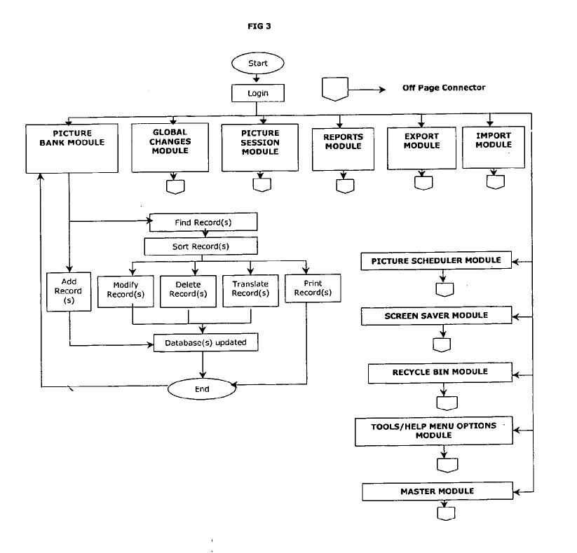

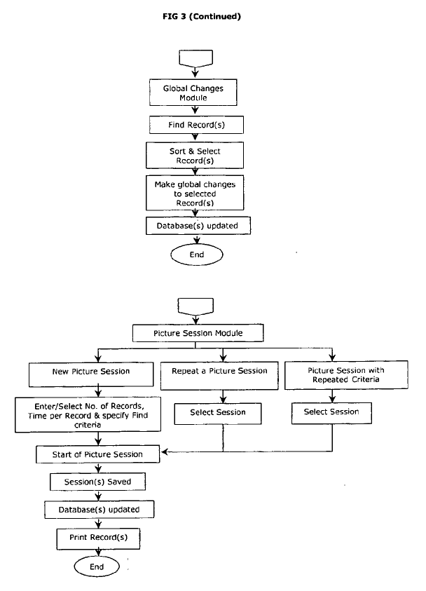

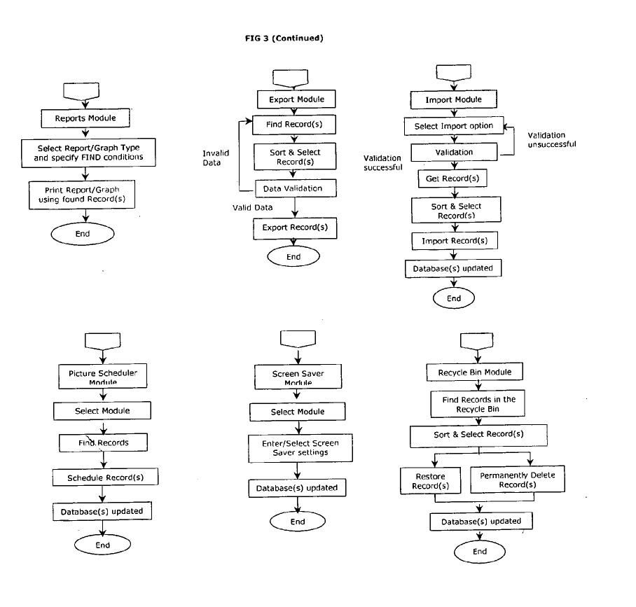

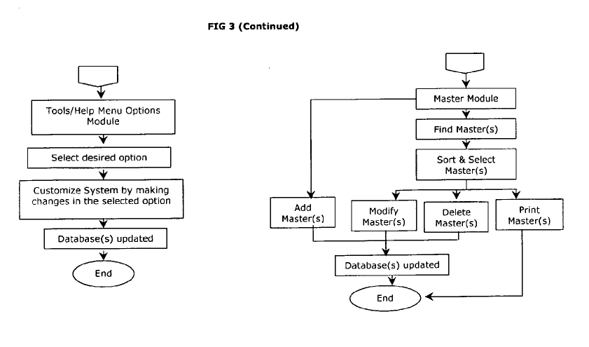

FIG. 3 is the diagram of the outline of the System Process of the present invention. It exhibits the Modules of the System and their main functions.

FIGS. 4 to 9 explain the System Function, System Operation, and System State Transition respectively of the Picture Bank Module and Global Changes Module respectively of the present invention. The Picture Bank Module allows the user to create, store, and organise Pictures by well-defined classifications. The Global Changes Module allows the user to globally Modify part(s) of Pictures, globally Delete Pictures, globally Bookmark Pictures, globally mark Pictures as “Public” or “Private”, and/or “Favourite”, globally Associate additional information in the form of File(s)/URL(s)/Remark(s) to Pictures, or globally Attach a File such as an Image, Animation, or a Sound file to Pictures.

FIG. 4 is the diagram of the System Function of the Picture Bank Module of the present invention. The architecture of this Module comprises the following functions, which allow a user to create, store, and organise Pictures by well-defined classifications with the help of the User Interface.

The Picture Bank Module through the User Interface causes the Control System to find and retrieve the relevant data from the Database(s). The Module allows a user to:
Create, store, and organise Pictures by well-defined classifications
Copy Current Entry
Find the available hierarchy(s) of Category and Sub Category
Find related Picture(s) having the same Classifications as that of the current Record, as may be defined by the user
Attach/Associate File(s)/URL(s)/Remark(s) to Picture(s)
Find existing Picture(s) from the Database(s) by none or one or more FIND conditions
Sort and Select Picture(s)
Modify Picture(s)
Delete Picture(s)
Go to a Picture and Navigate between Pictures
Print Picture(s) by various Print conditions
Bookmark Picture(s)
Mark Picture(s) as “Public” or “Private”
Mark Picture(s) as “Favourite”
Assign a Rating to the Picture(s)
Set the Picture as desktop wallpaper
View the Pictures stored in the Database(s) as thumbnails
View the Picture Properties
Export Picture(s) as Database file, or as Image file(s), or as MMS, or using Email, or using Network Messaging, or using the File Transfer Protocol (FTP)
Find and Import Picture(s) as Image file(s) from the hard disk or any similar storage device on a computer system

FIG. 5 describes the System Operation of the Picture Bank Module explaining that the Module is based on user actions. The Picture Bank Module accepts data (such data capable of being accepted from more than one user at the same time), by well-defined classifications like (1) Date (the same being generated automatically by the System and/or which can be modified by the user if needed), (2) Source of Information (to record the source from where the user obtained the Picture the user is storing—EXAMPLE—If the user may want to store a scanned photograph from the user's home album, then the Source of Information could be “HOME ALBUM”. Alternatively, if the user may want to create a Picture such as a Drawing or a Sketch, then the Source of Information could be the user's own name), (3) Type of Picture (to record the type of Picture that the user is creating and/or storing—EXAMPLE—If the user is storing a Picture such as a Photograph, then the Type of Picture in this case could be ‘PHOTOGRAPH’), (4) Creator of Picture (to record the name of the person who has created and/or stored the Picture—EXAMPLE—if a user has created and stored a Picture, then the Creator of Picture in this case could be the name of that user. Alternatively, if a user stores a Picture created by some other person, then the Creator of Picture in this case could be the name of that person), (5) Category (to record the category under which the Picture could be classified—EXAMPLE—a photograph of a formal occasion such as an anniversary may be classified under the Category ‘ANNIVERSARIES’), (6) Sub Category (to record the sub category to which the Picture belongs—EXAMPLE—If a particular Picture is classified under the Category ‘ANNIVERSARIES’, then its Sub Category could be ‘WEDDING ANNIVERSARY’)

When the user enters this Module, the Control System brings forth the User Interface of this Module from where the user can create and/or store Pictures by well-defined classifications, find the available hierarchy(s) of Category and Sub Category, find related Picture(s) having the same Classifications as that of the current Record, as may be defined by the user, Attach/Associate File(s)/URL(s)/Remark(s) to Picture(s), Find existing Picture(s) from the Database(s) by none or one or more FIND conditions, Modify Picture(s), Delete Picture(s), View the current Find result, Go to a Picture and Navigate between Pictures, Print Picture(s) by various Print conditions, Bookmark Picture(s), Mark Picture(s) as “Public” or “Private” as well as “Favourite”, assign a Rating, Set the Picture as desktop wallpaper, View the Pictures in the Database(s) as thumbnails, View the Picture Properties, Use the ‘Zoom’ option, Send Picture(s) as MMS or using Email or using Network Messaging or using the File Transfer Protocol (FTP), view Import Status, Export Picture(s), and Find and Import Picture(s) as Image file(s) from the hard disk or any similar storage device on a computer system. The user can also choose not to use any of these functionalities and close the User Interface to come out of the Module. All of these functionalities are described below in detail.

If the user chooses to create and/or store Pictures, the Control System brings forth a User Interface which prompts the user to copy the current Picture if any, facing the user, in terms of data input fields comprising of the Header (Classifications), Title of Picture, the Picture itself, Remarks, and/or Attachment/Association(s), such “Copy Current Entry” utility being of immense use to the user to simplify the creation and/or storage of Picture(s) having at least common Classifications. If a user selects to copy the Header (Classifications), then the Classifications under which the current Picture facing the user is classified, will be copied.—EXAMPLE—if a user has an existing Picture classified as:

### TITLE OF PICTURE: 25^{TH} WEDDING ANNIVERSARY

### SOURCE OF INFORMATION: HOME ALBUM

### CREATOR OF PICTURE: PETER

### CATEGORY: ANNIVERSARY

### SUB CATEGORY: WEDDING ANNIVERSARIES

And the new Picture created and/or stored by the user also happens to be falling under the above Classifications, the “Copy Current Entry” utility would make it easier for the user to create and/or store a new Picture, in that, the user would not have to reclassify the new Picture. If a user selects to copy the Picture itself and Remarks, the text and Remarks of the current Record facing the user will be copied. If a user selects to copy entries made in other data input fields for the current Record facing the user, then such entries will be copied accordingly. If a user selects to copy the Attachment and/or Associations to the current Record facing the user, then the Attachment and/or Associations will be copied accordingly. If a user chooses not to use this “Copy Current Entry” utility, then the Control System gets notified and blanks out all the relevant data input fields for new data input by the user.

The user can then check whether the user is duplicating an entry by choosing to find the available hierarchy of Category and Sub Category by which the Picture(s) are stored in the Database(s), as well as Picture(s) having the same Classifications as that of the current Picture facing the user. The hierarchy of Category and Sub Category is found according to what the user has entered as Category and/or Sub Category—EXAMPLE—If the user has not entered or selected any Category and/or Sub Category, the Control System brings forth all the available hierarchy(s) of Category and/or Sub Category by which the Picture(s) are classified and stored in the Database(s). If the user has entered or selected the Category as “ANNIVERSARIES”, the Control System brings forth the hierarchies of Category and Sub Category pertaining to the Category “ANNIVERSARIES”. Further if the user has entered or selected “ANNIVERSARIES” in either the Category or Sub Category, the Control System brings forth hierarchy(s) of Category and Sub Category where “ANNIVERSARIES” is there in either the Category or any of the Sub Category. The user can select any hierarchy from those brought forth and can enter this hierarchy in the data input fields provided for Category and Sub Category in the User Interface.

If the user chooses to find Picture(s) having the same classifications as that of the current Picture facing the user, the Control System brings forth a User Interface showing a grid which displays the Find Results accordingly.

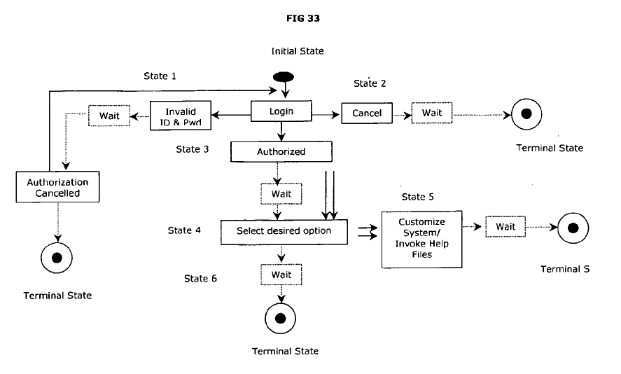

The user can create and/or store a Picture by entering accordingly in the relevant data input fields provided for the purpose. It is mandatory for the user to do this, else the Picture will not be saved in the Database(s). The user can enter or select relevant classifications in relevant data input fields for the Picture as mentioned above. The user can create and/or store a Picture in a data input field provided for the purpose. The user also has the option of adding Pictures and other types of graphics in this data input field. This data input field provides the user with various editing and formatting options for Pictures, text, and graphics. In addition, the data input field also provides various options such as modifying the colour scheme of the Picture, cropping the Picture, resizing the Picture and such others. The data input field provides the user with the option of creating and/or storing a Picture in any file format such as BMP, JPEG, GIF and such others. The user is also provided with the utility of invoking any external application to create, modify, and/or store a Picture in the data input field. This utility is described in the Choose Picture Editor option described in FIG. 32. The user also has a ‘Zoom’ option whereby the contents of this data input field are shown as zoomed in a separate User Interface. The user can view and modify the contents in the data input field through this User Interface. The user can also use this ‘Zoom’ option while navigating between Pictures. The user can further enter additional information about the Pictures, such as Title of Picture, Camera used, Location, Name of Photographer/Artist and further additional Remarks if any, in data input fields provided for the purpose.

The user can further choose to Attach/Associate additional information like File(s) including Image, Animation or Sound File(s), URL(s), and Remark(s) to the Record—EXAMPLE—The user may want to Attach a File such as an Image, Animation, or a Sound file, or the user may want to Associate more information by means of associating some information that may be on a File or a Web Site, and hence the user would Associate a File or URL. The user can open and view such File(s), provided the relevant applications for opening the File(s) are installed on the user's computer system. Further, in case of a File Attachment the user can open and view the same in a separate User Interface. In case of a URL, the same would be opened by the Control System provided the user is connected to the Internet. The user may also simply wish to Associate a REMARK to the Record. Such REMARKS are displayed to the user on demand. In case the user wants to Attach/Associate File(s), the Control System brings forth a User Interface from where the user must browse for and select the File(s), from a computer system. In case the user wants to Associate URL(s) or Remark(s), the user must enter the same into a data input field provided for the purpose. The user can further enter Remarks about each Attachment/Association in data input fields provided for the purpose. The user can further delete the Association(s) or remove the Attachment that the user might have given at this time. The Control System updates the Database(s) in this case. The user also has the further option of viewing the Attached File using the ‘Zoom Attachment’ option whereby the contents of the File are shown as zoomed in a separate User Interface.

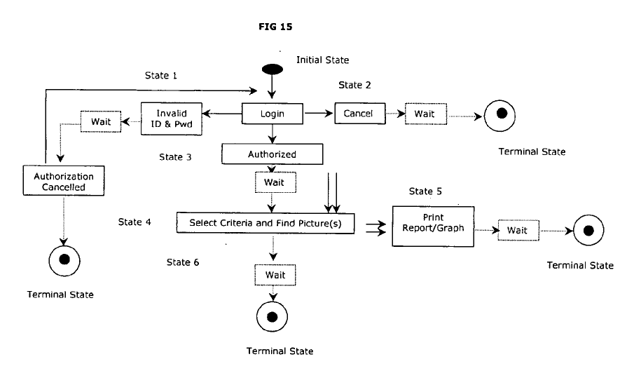

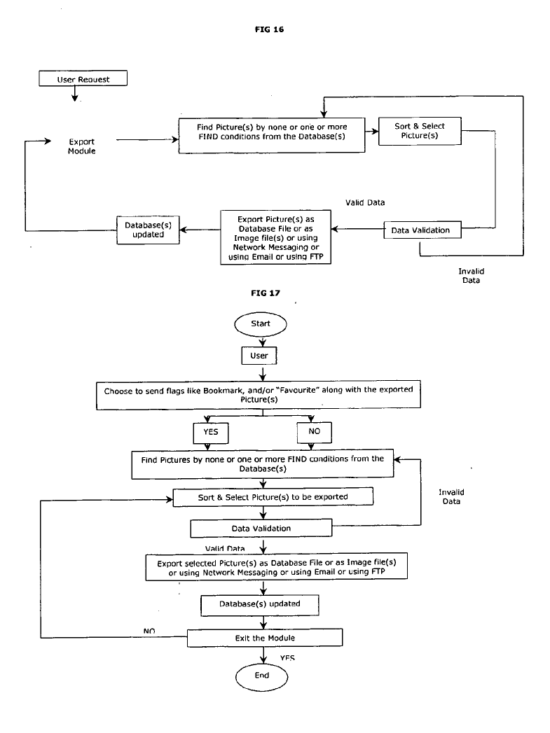

After the user creates and/or stores a Picture in the manner described above and chooses to save it, the Control System saves the same accordingly, generates a new Record Id for the same, and updates the Database(s). Alternatively, the user can store a Picture by importing it from a Database file, or as an Image file, or various media devices, or using the File Transfer Protocol (FTP) as described in detail in FIGS. 19 and 20. The Control System generates a new Record ID each time a new Picture is created and/or stored by a user or when a Picture is imported by the user.

If the user wants to find existing Picture(s) stored in the Database(s), the Control System brings forth a User Interface from where the user enters/selects a FIND criterion, and based on the same, the Control System finds and retrieves the Picture(s) from the Database(s). The user can find Picture(s) by none or one or more FIND conditions. The user can find Picture(s) stored in the Database(s) by a Date and Record Id range.—EXAMPLE—If the user wants to find Picture(s) created and/or stored between particular dates, the user has to select the appropriate dates in the From Date and To Date fields in the User Interface. If the user wants to find Picture(s) by their Record ID, then the user has to enter the Record Id of the desired Picture(s) in the From Record Id field and To Record Id fields of the User Interface. If the user wishes to find Picture(s) pertaining to the Source of Information ‘XYZ’, the user must enter or select the Source of Information ‘XYZ’ in the Source of Information field in the User Interface. If the user wishes to find Picture(s) such as photographs, the user must enter or select ‘PHOTOGRAPH’ in the Type of Picture field in the User Interface. If the user wishes to find Picture(s) which have the Title of Picture as ‘ABC’, the user must enter or select ‘ABC’ in the Title of Picture field of the User Interface. If the user wishes to find Picture(s) classified under the category ‘ANNIVERSARIES’, the user must enter ‘ANNIVERSARIES’ in the Category field in the User Interface. The user can further find Record(s) pertaining to any Sub Category.—EXAMPLE—The user can further find Picture(s) classified under the Sub Category ‘WEDDING ANNIVERSARY’ by entering or selecting ‘WEDDING ANNIVERSARY’ in the Sub Category field in the User Interface. Further, if the user wishes to find all Picture(s) that have been classified under the Category ‘ANNIVERSARIES’ and Sub Category ‘WEDDING ANNIVERSARY’, then the user must enter or select ‘ANNIVERSARIES’ and ‘WEDDING ANNIVERSARY’ in the Category and Sub Category fields respectively of the User Interface. The user can also enter relevant keywords in the keywords field of the User Interface, which would bring forth those Picture(s), the data input fields for Classification(s) and/or additional information of which contain the exact match or part thereof of the keywords entered by the user. The user can enter more than one keyword and can also choose to include or exclude the whole or part of any keyword—EXAMPLE—The user can enter one or more keywords separated by a space in the keywords field, and further the user can add a “+” separator or a “−” separator to include or exclude the subsequent word with respect to the immediately preceding word. The user can further enter the keyword within quotation marks to find Picture(s) whose Classifications containing the exact match for the keyword. The Control System searches for the keyword in all the data input fields for the Pictures and brings forth the Find Results accordingly. The user can further find Picture(s) by a criteria of whether or not the Picture(s) have been Bookmarked. In case where the Picture is Bookmarked, the user can find it by entering the appropriate Bookmark Remarks that the user may have assigned to the Picture at the time of bookmarking the Picture in the Module. The user has the further option of excluding the entered Bookmark Remark.—EXAMPLE—If the user has entered the Bookmark Remarks as “XYZ” and chooses to exclude the same, then the Control System will avoid showing those Picture(s) in the Find Results where “XYZ” is there in the Bookmark Remarks. The user can further find Picture(s) by a criteria of whether or not the Picture(s) have been marked as “Public” or “Private” as well as “Favourite”. The user can further find Picture(s) by specifying a Rating which the user may have assigned to the Picture(s) in the Module—EXAMPLE—If the user wants to find Picture(s) which have been assigned a Rating ‘*****’ then the user must select ‘*****’ in the Rating field of the User Interface. The user can further find Picture(s) by a Criteria of whether or not the Picture(s) have Associations and/or File Attachments. If the user selects to find Picture(s) that have File Attachments, the user must further select the type of the File Attachment as either an Image, Animation, or a Sound file. The user has a further option to exclude the type of the File Attachment.—EXAMPLE—If the user selects the type of the File Attachment as ‘IMAGE’ and chooses to exclude the same, the Control System will bring forth Find Results showing those Picture(s) which do not have Image files as Attachments. Further the user can find Picture(s) by entering the relevant Attachment and/or Association Remarks if any, related to the Attachment and/or Association of the Picture(s). The user has a further option to exclude the entered Attachment and/or Association Remark(s).—EXAMPLE—If the user has entered the Attachment and/or Association Remarks as “XYZ” and chooses to exclude the same, then the Control System will bring forth Find Results showing those Picture(s) where “XYZ” is not there in the Attachment and/or Association Remarks. The user can further find by whether or not the Picture(s) have been imported and further by Import Remarks, if any, given to the Pictures that were imported, with a further option to find by excluding the same in the same manner as described in case of Attachment/Association Remarks. The user can also choose to find by more than one master for a particular Criteria by using the Custom option.—EXAMPLE—the user can choose to find Picture(s) for the Type of Picture ‘PHOTOGRAPH’ as well as ‘ILLUSTRATION’ at a time. The user can further find Picture(s) by their Frequency of Occurrence—EXAMPLE—In case of Frequency of Occurrence, the user finds by whether or not a Picture has appeared in a Picture Session/Scheduled Session and if so, the number of times it has appeared, and also the time period in which it has appeared. The user has a further option to find Picture(s) by excluding the Frequency of Occurrence as may be specified by the user.

If the user chooses none of the FIND Criteria described above, then the Control System brings forth Find Results showing all the Picture(s) stored in the Database(s), by all the FIND Criteria. If the user chooses one of the FIND Criteria described above, then the Control System brings forth Find Results showing Picture(s) pertaining only to that FIND Criteria. If the user chooses more than one FIND Criteria described above, then the Control System brings forth Find Results showing Picture(s) pertaining to the Criteria chosen by the user. The System further provides the user with a utility whereby the user can specify the Control System to remember the FIND Criteria the next time when the user either chooses to find Picture(s) or when the user logs into the System. This utility is part of the Grid Option described in FIG. 32.

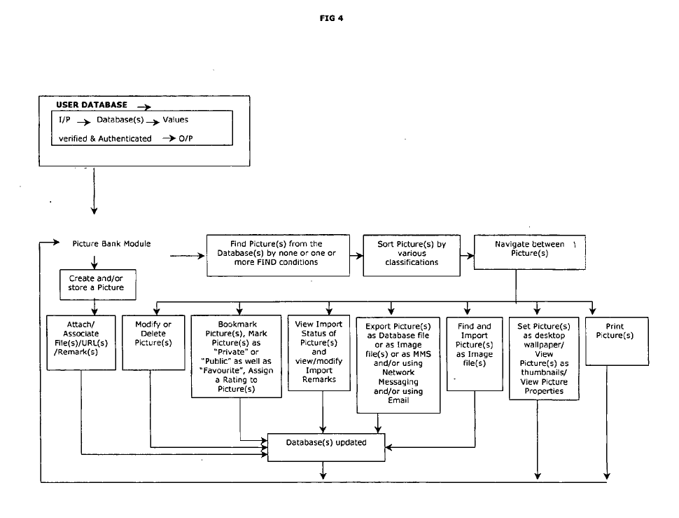

After the user has chosen to find the Picture(s) by none or one or more of the FIND conditions described above, the Control System brings forth a User Interface showing a grid displaying the Picture(s) brought forth according to the FIND conditions, and from where the user can Sort and Select the Picture(s) in the grid. The grid shows the Pictures in terms of their fields like Record Id, Title of Picture, Type of Picture, Creator of Picture, Category, Bookmark, Favourite, and Rating which are displayed as columns. The user can Sort the Pictures, in ascending or descending order, by Classifications as well as by other criteria like Record Id, whether or not the Picture(s) are Bookmarked, marked as “Public” or “Private” as well as “Favourite”, or have Attachment/Associations. The user can apply the Sort condition to the Picture(s) currently displayed in the Find Result grid facing the user or the entire set of found Pictures. The user can Sort the Picture(s), in ascending or descending order, by clicking on any column in the grid.—EXAMPLE—If the user clicks on the Category column, then all the Pictures in the grid will get sorted by Category of the Pictures in ascending or descending order. Further, the user can select the Picture(s) in the grid and further view all the selected Picture(s) through a “Selected So Far” utility. The Control System brings forth a User Interface wherein the user can further Sort and select Picture(s) as well as undo this selection. The user can also view the details of the Picture(s) in a separate User Interface. The user can further print the selected Picture(s). The user can further make global changes to the selected Picture(s), as described in FIGS. 7 and 8.

The following utilities are available to a user from the User Interface displaying the Find Result grid:

1. Sorting and Selecting the Picture(s) by various Classifications and other criteria as explained above
2. Selecting single or multiple Pictures as well as undoing selections of the same as explained above
3. Viewing details of selected Picture(s) as explained above
4. Viewing selected Picture(s) in another User Interface through a ‘Selected so far’ utility, with a further possibility to undo the selections on the Picture(s) from this User Interface.
5. Viewing existing Bookmark Remarks of the Picture(s) as well as adding, modifying, or removing Bookmark Remarks.
6. Printing the selected Picture(s) by various Print Options.
7. Making global changes as mentioned above
8. Taking a Picture Session using the selected Picture(s) as explained below
9. Scheduling the selected Picture(s) as explained below
10. Exporting the selected Picture(s) as explained below

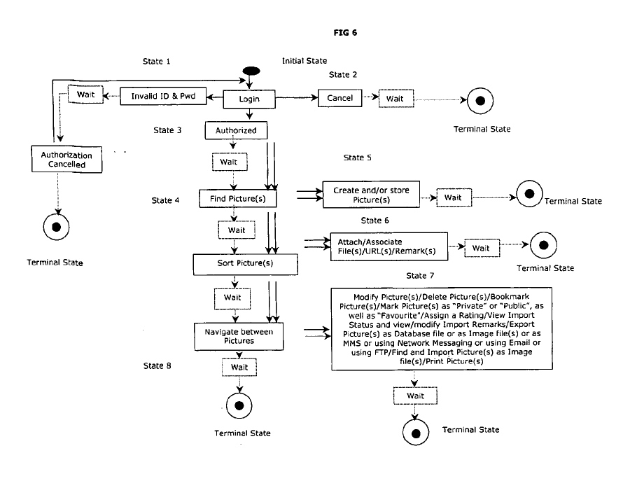

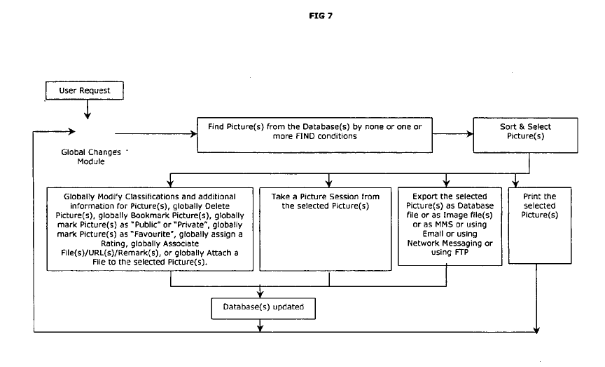

If the user chooses to take a Picture Session from the selected Picture(s), then the Control System brings forth a User Interface from where the user can enter/select Criteria like the Picture Session Title, time of display per Picture, select to activate Background Music during the Picture Session, and start the Picture Session. The Control System then starts a Picture Session which is described in detail in FIGS. 10 and 11. At the end of a Picture Session, the Control System saves the Picture Session, generates a new Picture Session Id for the same, and thus updates the Database(s). After the user has taken an Picture Session in this manner, the Control System then takes the user back to the User Interface displaying the Find Result grid.

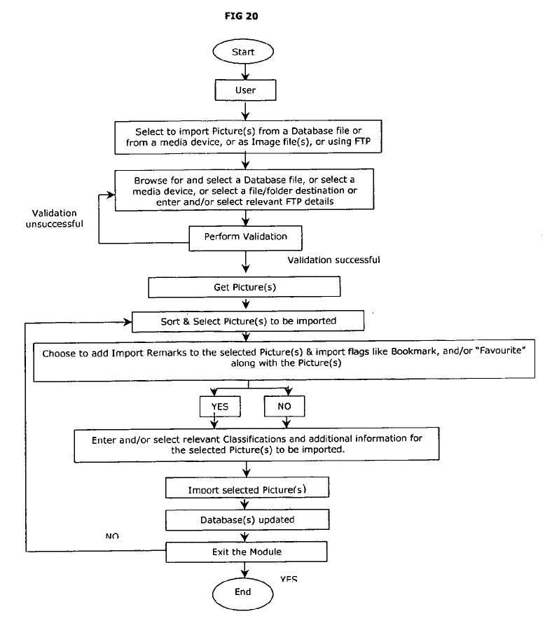

If the user chooses to Schedule the selected Picture(s), the Control System brings forth a User Interface from where the user can enter/select Criteria like Scheduled time of display, Scheduled Date, Select to activate Background Music, choose between scheduling the Picture(s) or scheduling Picture Session(s) using the Picture(s). The Scheduling activity is described in detail in FIGS. 22 and 23. The Control System schedules the Picture(s) accordingly to be displayed on the user's computer system at the scheduled time, saves such a Scheduled Session, generates a new Scheduled Session Id, and thus updates the Database(s). After the user has scheduled the selected Picture(s), the Control System then takes the user back to the User Interface displaying the Find Result grid.

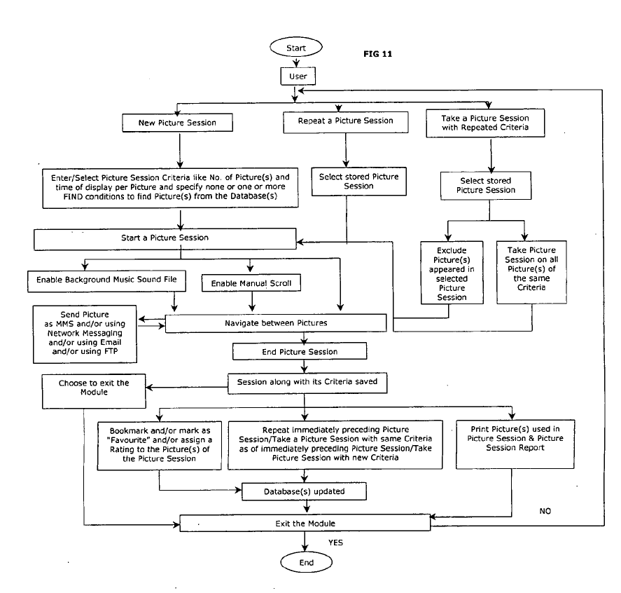

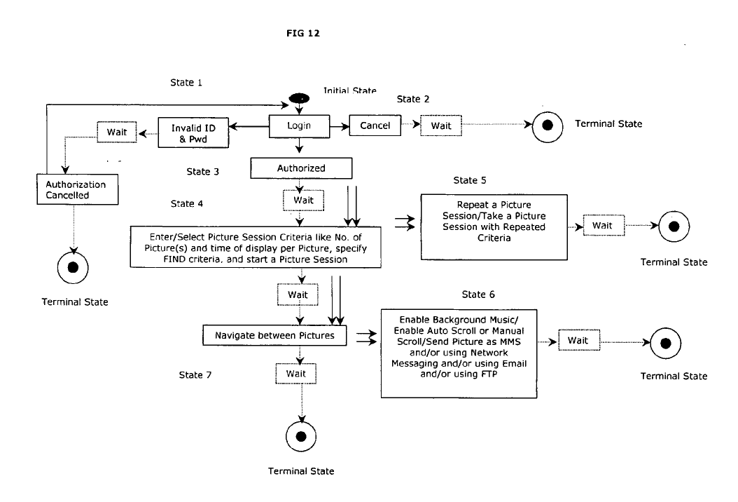

If the user chooses to Export the selected Picture(s), the Control System prompts the user as to whether the user wishes to export selected Picture(s) in the form of a Database file or as Image file(s), or as MMS or using Email or using Network Messaging, or using the File Transfer Protocol (FTP). Depending on the user's choice, the Control System exports the Picture(s) accordingly, notifies the user that the Picture(s) were successfully exported and also displays the number of Picture(s) exported. The utility(s)/functionality(s) available to the user at the time of exporting Picture(s), as described in FIGS. 16 and 17, are also available in this case. After the user exports the selected Picture(s), the Control System then takes the user back to the User Interface displaying the Find Result grid.

Double clicking on any Picture in the Find Result grid will take the user to the Picture in the Module. The Find results brought forth for a particular criteria are saved until the user finds Picture(s) by new criteria, or closes the User Interface displaying the Picture Bank Module. The user has the option of viewing the latest Find result for a particular Find criteria through the User Interface of the Picture Bank Module.

If the user wishes to Modify an existing Picture in this Module, all the utility(s)/functionality(s) available at the time of creating and/or storing the Picture would be available to the user and using the same, the user can make further modifications in the same if required. After modification, if the user chooses to save, the Control System saves the modifications and updates the Database(s).

If the user wishes to Delete an existing Picture in this Module, the Control System prompts the user as to whether or not the user wishes to do so. If the user chooses to continue, the Control System deletes the Picture from the Module, sends it to the Recycle Bin of the System, and updates the Database(s).

The user can further navigate between the Pictures of this Module and can also choose to directly go to a Picture by entering its Record Id or Entry Title in data input fields provided for the purpose. The user has the further option of going to the last viewed Picture.—EXAMPLE—When a user enters the Picture Bank Module, the current Picture displayed to the user is the latest Picture that has been added to the Database(s). If the user now goes to any other Picture say having Record Id as 30 and wishes to return to the Picture last viewed i.e. the latest Picture in this case, then the user can use the ‘Back’ option to do so. If the user thus goes to the Picture last viewed by using this option, the user can also return to the Picture having Record Id as 30 by using the ‘Forward’ option. The Control System maintains a history of the Picture(s) viewed by the user till the user exits the Module. By using the ‘Back’ and ‘Forward’ options, the user can navigate between such Picture(s).

If the user chooses to Bookmark a Picture in this Module, then the Control System brings forth a User Interface from where the user must enter some Bookmark Remarks in order to Bookmark the Picture. The user can also view the earlier Bookmark Remarks, if any, and can further modify the same. The Control System bookmarks the Picture accordingly. From the User Interface, the user can also remove the flag of Bookmark from the Picture. The Control System updates the Database(s) whenever a Picture is Bookmarked or the Bookmark flag is removed from it.

If the user chooses to mark a Picture in this Module as “Public” or “Private” and/or “Favourite”, the Control System flags the Picture accordingly. Further when a Picture is marked as “Private” by a user who has logged in to the System, the Picture will not be visible to other users who log into the same System at any other point of time. The user can also choose to remove the flag of “Public” or “Private” and/or “Favourite”. The Control System updates the Database(s) whenever a Picture is marked as “Public” or “Private” and/or “Favourite”, or whenever these flags are removed from the Picture.

If the user chooses to assign a Rating to a Picture in this Module, then the Control System brings forth a User Interface from where the user must select the appropriate Rating in order to assign it to the Picture. The Ratings in this case would be in the form of “*”, “**”, “***”, “****” and “*****”. The Ratings can be assigned according to the Picture.—EXAMPLE—a Picture such as a well taken photograph could be assigned a Rating of “*****” i.e. a high Rating. The Control System updates the Database(s) whenever a Picture is assigned a Rating or the existing Rating assigned to a Picture, if any, is modified.

If the user chooses to set the current Picture facing the user in the User Interface of the Picture Bank Module as a desktop wallpaper, then the Control System gets notified and sets the Picture as a desktop wallpaper on the user's computer system.

If the user chooses to View the Pictures stored in the Database(s) as thumbnails, the Control System gets notified and brings forth a User Interface displaying the Pictures stored in the Database(s) as thumbnails. The user can navigate between the thumbnails of the Pictures in this User Interface. If the user selects or highlights a thumbnail of a particular Picture in this User Interface, then that Picture will be displayed in the User Interface of the Picture Bank Module.

If the user chooses to view the Picture Properties of the Picture(s) stored in the Database(s), the Control System brings forth a User Interface displaying Picture Properties such as File format, File size, Dimensions in pixels, Picture Resolution, Colour mode, Creation date and time in case the Picture was imported as described in FIGS. 19 and 20, and such others. The parameters for Picture Properties such as File Format, File size, Dimensions in pixels, and such others for a particular Picture will change automatically if the user chooses to modify that Picture, and save the modifications done.

If the user chooses to print Picture(s) in this Module, the Control System brings forth a print preview of the same, from which the user can print further. The user can further choose to print Picture(s) found by a FIND condition as specified by the user, in the same manner as that of the current Picture facing the user. The Printing utility further allows the Print reports to be Exported to various destinations in various file formats.

If the user chooses to view Import Status of a Picture in this Module, the Control System will bring forth a User Interface showing whether or not the Picture has been imported by the ways described in FIGS. 19 and 20. The user can further view and modify the Import Remarks associated with the Picture in a data input field provided for the purpose. The user can further choose to remove the Import Remarks. The Control System updates the Database(s) whenever the Import Remarks are added, modified, or removed.

If the user chooses to Export current Picture facing the user in the User Interface of the Picture Bank Module, the Control System prompts the user as to whether wishes to the export the Picture by means of a Database file created by the System, or as an Image file or as MMS or using Email or using Network Messaging, or using the File Transfer Protocol (FTP). Depending on the user's choice the Control System exports the Picture accordingly, notifies the user that the Picture was successfully exported and also displays the number of Picture exported. The utility(s)/functionality(s) available to the user at the time of exporting Picture(s), as described in FIGS. 16 and 17, are also available in this case.

The Module also accepts data created by another user (Exporting user) of the System, and which may be further manipulated by the user (Importing user) to suit the user's requirements. (EXAMPLE—the Exporting user may have classified a photograph of a geographical feature such as a lake under the category GEOGRAPHY, but the Importing user would like to classify the same under the category WATER BODIES)

If the user chooses to find and import Picture(s) as image file(s) from the hard disk or any similar storage device on a computer system, the Control System gets notified and brings forth a User Interface showing the Find result wherein all the Image file(s) on the computer system are displayed as thumbnails. From here, the user can select the Image file(s) and choose to import them in the same manner as described in FIGS. 19 and 20.

Any data entered or imported into the Picture Bank Module is further used as part of the functions of the other Modules of the System.

FIG. 6 describes the System State Transition of the Picture Bank Module explaining that the Module is based on different States. The System receives events from the user(s), and each event causes the transition from one state to another within the Module.

Each State contains its own separate Terminal State. A double lined transition arrow from State 4 indicates that multiple instances of the State are possible. So it is possible for multiple instances of State 4 to occur, each of which has its own Terminal State. A transition showed with a dotted line indicates that it is leaving from one State and entering another State.

FIG. 7 is the diagram of the System Function of Global Changes Module of the present invention. The architecture of this Module comprises the following major functions, which allow a user to make global changes to the Pictures stored in the Database(s) like globally Modifying Classifications and other additional information for Pictures, globally Deleting Pictures, globally Bookmarking Pictures, globally marking Pictures as “Public” or “Private”, globally marking Pictures as “Favourite”, globally assigning a Rating to Pictures, globally Associating additional information in the form of File(s)/URL(s)/Remark(s) to Pictures, or globally Attaching a File such as an Image, Animation, or a Sound file to Pictures, with the help of the User Interface.

The Module allows a user to:
Find existing Pictures from the Database(s) by none or one or more FIND conditions
Sort and Select Picture(s)
Globally Modify Classifications and other additional information for Picture(s), globally Delete Picture(s), globally Bookmark Picture(s), globally mark Picture(s) as “Public” or “Private”, globally mark Picture(s) as “Favourite”, globally assign a Rating to Picture(s), globally Associate additional information in the form of File(s)/URL(s)/Remark(s) to Picture(s), or globally Attach a File such as an Image, Animation, or a Sound file to Picture(s).

FIG. 8 describes the System Operation of the Global Changes Module, explaining that the Module is based on user actions.

When the user enters this Module, the Control System brings forth a User Interface from where the user must find Picture(s) from the Database(s) by none or one or more FIND conditions for making global changes. The FIND conditions in this case are the same as the ones described in FIG. 5. The Control System brings forth a User Interface, displaying the Find Results in a grid, and from where the user can Sort and Select the Picture(s) for making global changes. The User Interface provides the user with the same utility(s)/functionality(s) applicable to Picture(s) in a Find Result grid as described in FIG. 5. Double clicking on any Picture in the grid will take the user to the Picture in the Picture Bank Module. The user can choose to either globally Modify Classifications and other additional information, globally Delete, globally Bookmark, globally mark as “Public” or “Private”, globally mark as “Favourite”, globally assign a Rating, globally Associate additional information in the form of File(s)/URL(s)/Remark(s), globally Attach a File such as an Image, Animation, or a Sound file, to the selected Picture(s).

If the user chooses to globally Modify Classifications and other additional information for selected Picture(s), the Control System brings forth a User Interface from where the user can select the desired data input field for Classification and/or additional information of the Picture(s) that the user wishes to Modify, enter/select to find that which is to be replaced in that selected data input field, and further enter/select to Replace that which is thus found, in specific data input fields provided for the purpose.—EXAMPLE—If the user selects a data input field like Category, for the selected Picture(s), the user can select to find the Category say ‘ANNIVERSARIES’ and can enter or select to Replace it with the Category ‘FORMAL OCCASIONS’. The Control System searches the Category field of the selected Picture(s) for ‘ANNIVERSARIES’ and replaces it with ‘FORMAL OCCASIONS’. Further, if the user selects a data input field like Remarks, then the user must enter some text which the user wishes to find to be replaced in the Remarks field and then enter the text that will replace this found text.—EXAMPLE—If the user enters ‘ABC’ to be found to be replaced and then enters ‘XYZ’ as the text to Replace ‘ABC’, the Control System will search the Remarks field of the selected Picture(s) for all occurrences of ‘ABC’ and Replace it with ‘XYZ’. After entering or selecting to find and Replace, the Control System prompts the user as to whether or not the user wants to do the same. If the user continues, the Control System modifies the selected Picture(s) accordingly, notifies the user that the selected Picture(s) have been modified, and displays the number of Picture(s) modified. The Control System updates the Database(s) whenever the Picture(s) are modified.

If the user chooses to globally Delete the selected Picture(s), the Control System prompts the user as to whether or not the user wishes to Delete the selected Picture(s). If the user continues, the Control System deletes the selected Picture(s) from the grid, notifies the user that the Picture(s) have been deleted, and also displays the number of Picture(s) deleted. The Control System sends the deleted Picture(s) to the Recycle Bin of the System and updates the Database(s) accordingly.

If the user chooses to globally Bookmark the selected Picture(s), the Control System prompts the user as to whether or not the user wishes to do the same. If the user continues, the Control System brings forth a User Interface where the user must enter some Bookmark Remarks in order to Bookmark the selected Picture(s). After the user enters the Bookmark Remarks and saves the same, the Control System prompts the user as to whether the user wishes to overwrite or append to the existing Bookmark Remarks, if any, of the selected Picture(s) in case such Picture(s) have been bookmarked earlier. After the user selects either to overwrite or append to the existing Bookmark Remarks, the Control System bookmarks the Picture(s) accordingly, notifies the user that the Picture(s) have been bookmarked, and displays the number of Picture(s) bookmarked. The user can view the existing Bookmark Remarks of all Picture(s) in the Find Result grid, in case such Picture(s) have been bookmarked earlier. The user can further remove the Bookmark flag of the selected Picture(s) in case such Picture(s) have been bookmarked earlier. The Control System updates the Database(s) whenever the Picture(s) are bookmarked, or the existing Bookmark Remarks of Picture(s) are modified, or whenever the Bookmark flag is removed from the Picture(s) which have been bookmarked earlier.

If the user chooses to globally mark the selected Picture(s) as “Public” or “Private”, the Control System brings forth a User Interface where the user must select either to mark the Picture(s) as “Public” or “Private”. After the user selects either one of these two options, the Control System prompts the user as to whether or not the user wishes to thus mark the selected Picture(s). If the user continues, then the Control System marks the selected Picture(s) as “Public” or “Private” as may be specified by the user, notifies the user that the Picture(s) have been thus marked, and displays the number of Picture(s) thus marked. The user can also remove the “Public” and “Private” flags of the selected Picture(s) in case such Picture(s) have been marked earlier as “Public” or “Private”. The Control System updates the Database(s) whenever the Picture(s) are marked as “Public” or “Private” or whenever the flags of “Public” or “Private” are removed from Picture(s) which have been marked earlier as “Public” or “Private”.

If the user chooses to globally mark the selected Picture(s) as “Favourite”, the Control System prompts the user as to whether or not the user wishes to thus mark the selected Picture(s). If the user continues, then the Control System marks the selected Picture(s) as “Favourite”, notifies the user that the Picture(s) have been thus marked, and displays the number of Picture(s) thus marked. The user can also remove the “Favourite” flag of the selected Picture(s) in case such Picture(s) have been marked earlier as “Favourite”. The Control System updates the Database(s) whenever the Picture(s) are marked as “Favourite” or whenever the flag of “Favourite” is removed from Picture(s) which have been marked earlier as “Favourite”.

If the user chooses to globally assign a Rating to the selected Picture(s), the Control System prompts the user as to whether or not the user wants to do the same. If the user continues, the Control System brings forth a User Interface from where the user can select the appropriate Rating that the user wishes to assign to the selected Picture(s) in the same manner as described in FIG. 5. After the user has selected the appropriate Rating and continues, the Control System assigns the Rating to the selected Picture(s), notifies the user that the Picture(s) have been assigned a Rating, and displays the number of Picture(s) which have been assigned a Rating. The user can also modify or remove the Rating(s) assigned to the selected Picture(s), in case such Picture(s) have been assigned a Rating earlier. The Control System updates the Database(s) whenever the Picture(s) are assigned a Rating or whenever the existing Rating assigned to the selected Picture(s) is modified or removed.

If the user chooses to globally Associate File(s)/URL(s)/Remark(s) to the selected Picture(s), the Control System prompts the user as to whether or not the user wants to do the same. If the user continues, the Control System brings forth a User Interface from where the user can Associate File(s)/URL(s)/Remark(s), and also add Remarks about such associations. In case the user wants to Associate File(s) with the Picture(s), the user can browse for and select the File(s), from a computer system. In case the user wants to Associate URL(s) or Remark(s), the user must enter the same into a data input field provided for the purpose. The user can further enter Remarks about each Association in a data input field provided for the purpose. From the User Interface, the user can also open and view the Associated File or URL and further can delete the Association(s) that the user might have given to the selected Picture(s) at this time. If the user chooses to save the Association(s), then the Control System Associates the File(s)/URL(s)/Remark(s) to the selected Picture(s), notifies the user about the same, and displays the number of Picture(s) to which either File(s)/URL(s)/Remark(s) have been associated. The user can also delete all Association(s) of the selected Picture(s) in case such Picture(s) have been associated with File(s)/URL(s)/Remark(s) earlier. The Control System updates the Database(s) whenever File(s)/URL(s)/Remark(s) are associated and/or Association Remarks are added to the selected Picture(s) or whenever any previous Associations are deleted from the selected Picture(s).

If the user chooses to globally Attach a File to the selected Picture(s), the Control System prompts the user as to whether or not the user wants to do the same, also notifying the user that the Attachment made by the user at this time will replace the earlier Attachment, if any, of the selected Picture(s). If the user continues, the Control System brings forth a User Interface from where the user can Attach a File, and add Remarks about this Attachment. In order to Attach a File with the Picture(s), the user must browse for and select the File, from a computer system. The user can further enter Remarks about the Attachment in a data input field provided for the purpose. From the User Interface, the user can also open and view the Attached File. If the user chooses to save the Attachment, then the Control System prompts the user to choose whether to Attach the File to all of the selected Picture(s) or only to those selected Picture(s) which do not have any File Attachment. Depending on the user's choice, the Control System Attaches the File to the selected Picture(s) accordingly, notifies the user about the same, and displays the number of Picture(s) to which the File has been attached. The user can also delete the Attachment(s) of the selected Picture(s) in case such Picture(s) have been attached with a File earlier. The Control System updates the Database(s) whenever a File is attached with or without adding Attachment Remarks, to the selected Picture(s) or whenever any previous Attachment is deleted from the selected Picture(s).

When the user closes the User Interface from where the user can make global changes as described above, the Control System gets notified and the user comes out from the Module.

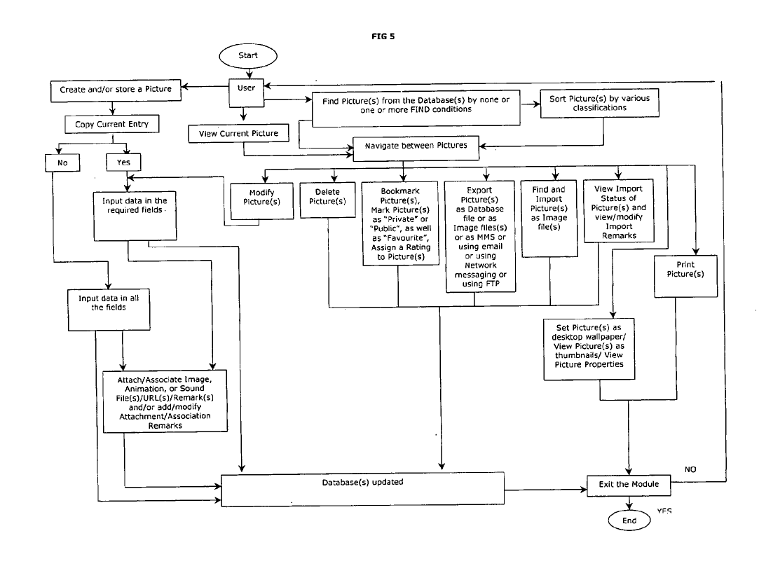

FIG. 9 describes the System State Transition of the Global Changes Module explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 10 to 12 explain the System Function, System Operation and System State Transition respectively of the Picture Session Module, which allows the user to invoke and store an Picture Session (such Picture Sessions capable of being taken by more than one user at the same time), using the data stored in the Database(s).

FIG. 10 is the diagram of the System Function of Picture Session Module of the present invention. The architecture of this Module comprises of the following major functions, which allow a user to invoke a Picture Session using the Picture(s) stored in the Database(s), with the help of the User Interface.

The Module allows a user to:
Enter/Select Criteria like Picture Session Title, No. of Pictures to appear in the Picture Session, and time of display per Picture
Activate Background Music
Take a Picture Session by using the Picture(s) found from the Database(s) by none or one or more FIND conditions
Navigate manually (Manual Scroll) or automatically (AutoScroll) between Pictures during a Picture Session
Send Picture(s) as MMS and/or using Email or/using Network Messaging and/or using the File Transfer Protocol (FTP) during a Picture Session
Bookmark Picture(s) related to a Picture Session
Mark as “Favourite” and/or assign a Rating to the Picture(s) related to a Picture Session
Print Picture(s) related to a Picture Session
Repeat a Picture Session
Take a Picture Session with Repeated Criteria

FIG. 11 describes the System Operation of the Picture Session Module, explaining that the Module is based on user actions.

When the user enters this Module, the Control System brings forth a User Interface from where the user can enter/select Criteria like Picture Session Title, No. of Pictures that the user wishes to appear in the Picture Session, and time of display per Picture, specify none or one or more FIND conditions to find the Picture(s) from the Database(s) to be used in the Picture Session, select to listen to a Background Music Sound File during the Picture Session, and start a Picture Session. The FIND conditions in this case are same as the ones described in FIG. 5.

After the user makes the necessary entries/selections and starts the Picture Session, the Control System brings forth a User Interface which displays the Picture Session, showing Picture(s) found from the Database(s) according to the FIND conditions specified by the user, one after the other along with the time of display per Picture as may be specified by the user. The Title of the Picture(s) and the Category under which the Picture(s) may have been classified in the respective Module to which the Picture(s) belong, is additionally displayed. In case the user enters the No. of Picture(s) that the user wishes to appear in the Picture Session, that many Picture(s) are randomly selected from the Database(s) according to the FIND conditions. Else, the Control System will bring forth all the available Picture(s), which satisfy the FIND conditions, to be displayed in the Picture Session. From the User Interface, the user can view the details of the Picture(s) displayed one by one. The user can further select whether or not to listen to the Background Music during the Picture Session at any point of time. The user can select between either automatically or manually navigating between the Picture(s). In case of automatic navigation, a Picture is automatically displayed to the user for the time of display per Picture as may be specified by the user. The Picture(s) are thus displayed one by one to the user until all the Picture(s) that are to appear in the Picture Session, as specified by the user, have been displayed. In case of manual navigation, the user can navigate back and forth between the Picture(s). There is no time of display per Picture in this case. The user can switch between automatic and manual navigation at any point of time during the Picture Session.

The user can further select to view or play an Attached File, if any, of the Picture(s) during the Picture Session. In case the Attached File is an Animation or Sound file, the Control System will invoke the relevant application, if installed on the user's computer system, to play the same. While in case if the Attached File is an Image file, the Control System automatically displays the same. The user can also send any Picture(s) as MMS and/or using Email and/or using Network Messaging and/or using the File Transfer Protocol (FTP) during the Picture Session. The user can, at any point of time, either choose to close the User Interface displaying the Picture Session, or choose to end the Picture Session.

If the user chooses to close the User Interface displaying the Picture Session, the Control System closes the User Interface, saves the Picture Session along with its Criteria, generates a new Picture Session Id, and thus updates the Database(s). The user then comes out of the Module.

If the user chooses to end the Picture Session, the Control System closes the User Interface displaying the Picture Session, saves the Picture Session along with its Criteria, generates a new Picture Session Id, and thus updates the Database(s). The Control System then brings forth a User Interface showing a grid which displays the Picture(s) that were brought forth during the Picture Session, and from where the user can choose options like repeating the immediately preceding Picture Session, taking a Picture Session with same Criteria as that of the immediately preceding Picture Session, or taking a Picture Session with new Criteria. The user can further choose to print Picture(s) displayed in the immediately preceding Picture Session, print a Picture Session Report, or entire details of Picture(s), as well as make global changes, as described in FIGS. 7 and 8, to the Picture(s) displayed in the immediately preceding Picture Session. The user can chose not to select any of these options and further close the User Interface to come out of the Module.

If the user chooses to repeat the immediately preceding Picture Session, the Control System starts the Picture Session by bringing forth a User Interface displaying the same, showing the same Picture(s), which were displayed in the immediately preceding Picture Session. At the end of this Session, the Control System saves the same along with its Criteria, generates a new Picture Session Id, and updates the Database(s). The Control System will now treat this saved Picture Session as a separate Picture Session.

If the user chooses to take an Picture Session with same Criteria as that of the immediately preceding Picture Session, the Control System brings forth a User Interface from where the user can choose between selecting to take a Picture Session by excluding Picture(s) that have already appeared in the immediately preceding Picture Session taken by the same Criteria, or selecting to take a Picture Session with all the Picture(s) by the same Criteria as that of the immediately preceding Picture Session. The Control System starts a Picture Session by bringing forth a User Interface displaying the same, showing the Picture(s) according to the user's selections. The Control System saves this Picture Session along with its Criteria, generates a new Picture Session Id, and thus updates the Database(s).

If the user chooses to take a Picture Session with new Criteria, the Control System brings forth a User Interface from where the user can enter/select Picture Session Criteria and start the Picture Session as described earlier. The Control System starts a Picture Session by bringing forth a User Interface displaying the Picture Session, showing the Picture(s) according to the user's selections. The Control System saves this Picture Session along with its Criteria, generates a new Picture Session Id, and thus updates the Database(s).

If the user wishes to print the Picture(s) of the immediately preceding Picture Session, the user can select all or specific Picture(s) to be thus printed. The Control System brings forth the print previews accordingly from where the user can print further.

If the user chooses to make global changes to the Picture(s), the Control System brings forth a User Interface displaying these Picture(s) in a Find Result grid from where the user can make global changes as described in FIGS. 7 and 8. Further, this User Interface provides the user with the same utility(s)/functionality(s) applicable to Picture(s) in a Find Result grid as described in FIG. 5.

In case the user wishes to repeat a Picture Session that has been taken earlier, the Control System brings forth a User Interface showing a grid which displays all the Picture Session(s) taken earlier. The user can Sort the Picture Session(s) in the grid, in ascending or descending order, by Criteria like Picture Session Title, number of Picture(s) appeared in the Picture Session, and Date on which the Picture Session was taken. The user can also view the Criteria by which the Picture Session(s) were taken. Further, if the user selects any Picture Session in the grid, the Control System displays the details of the Picture(s) appeared in that selected Picture Session, in another grid. After the user selects the desired Picture Session, the Control System starts the Picture Session by bringing forth a User Interface displaying the same. After the end of this Picture Session, the Control System saves the same, generates a new Picture Session Id, and updates the Database(s). The utility(s)/functionality(s) provided by the Module after the end of a Picture Session, as described above, are also applicable in this case.

In case if the user wishes to take a Picture Session with the same Criteria as that of an Picture Session taken earlier, then the Control System brings forth a User Interface showing a grid which displays all the Picture Session(s) taken earlier for the selected Module. The general functionality(s) related to this User Interface like sorting the Picture Session(s), viewing the details of the same, are the same as those in the User Interface brought forth in case of repeating a Picture Session. After the user selects the desired Picture Session, the Control System brings forth a User Interface from where the user must choose between selecting to take a Picture Session by excluding Picture(s) that have already appeared in the selected Picture Session taken by the same Criteria, or selecting to take a Picture Session with all the Picture(s) by the same Criteria as that of the selected Picture Session. The Control System starts a Picture Session by bringing forth a User Interface displaying the same, showing the Picture(s) according to the user's selections. The Control System saves this Picture Session along with its Criteria, generates a new Picture Session Id, and thus updates the Database(s). The utility(s)/functionality(s) provided by the Module after the end of a Picture Session, as described above, are also applicable in this case.

In case the user wishes to print the Picture(s) appeared in a Picture Session that has been taken earlier, the Control System brings forth a User Interface showing a grid which displays all the Picture Session(s) taken earlier. The user can Sort the Picture Session(s) in the grid, in ascending or descending order, by Criteria like Picture Session Title, number of Picture(s) appeared in the Picture Session, and Date on which the Picture Session was taken. The user can also view the Criteria by which the Picture Session(s) were taken. Further, if the user selects any Picture Session in the grid, the Control System displays the details of the Picture(s) appeared in that selected Picture Session, in another grid. After the user selects the desired Picture Session for printing, the Control System brings forth a print preview of the Picture(s) that appeared in that Picture Session from where the user can further print accordingly.

Note: The Picture Session(s) taken by a particular user who has logged into the System are not visible to any other user who logs into the same System at a different point of time.

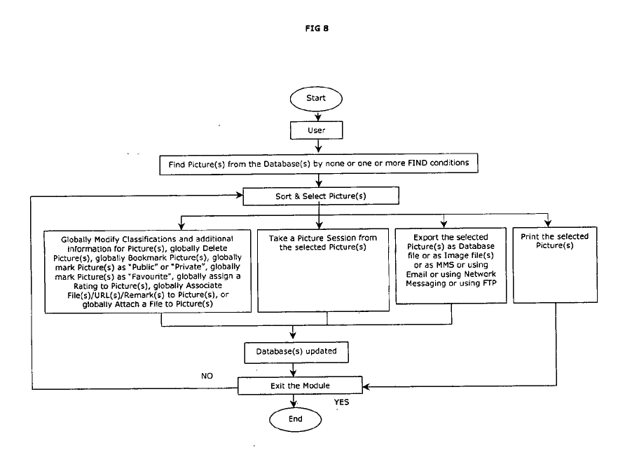

FIG. 12 describes the System State Transition of the Picture Session Module explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

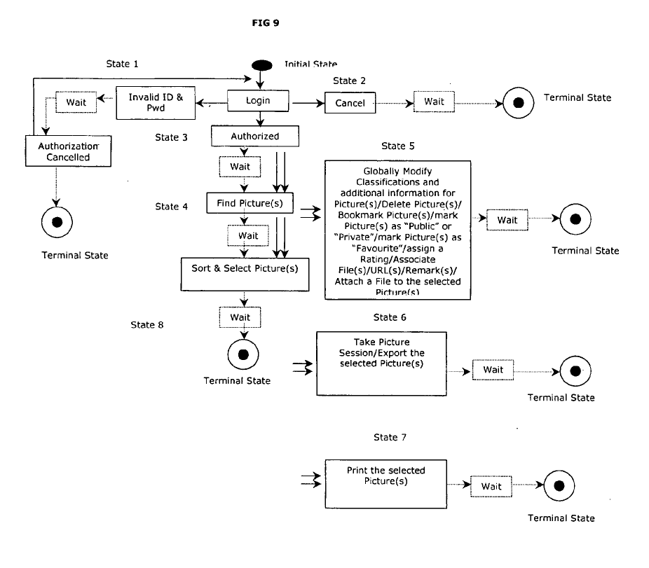

FIGS. 13 to 15 explain the System Function, System Operation, and System State Transition respectively of the Reports Module which allows a user to obtain Reports and/or Graphs.

FIG. 13 is the diagram of the System Function of Reports Module of the present invention. The architecture of this Module comprises the following major functions, which allow a user to obtain Reports and/or Graphs with the help of the User Interface.

The Module allows a user to:
Select a Report type
Select Criteria
Print Report/Graph with or without the details of the selected Criteria by using Picture(s) found from the Database(s) by none or one or more FIND conditions, pertaining to the selected Report

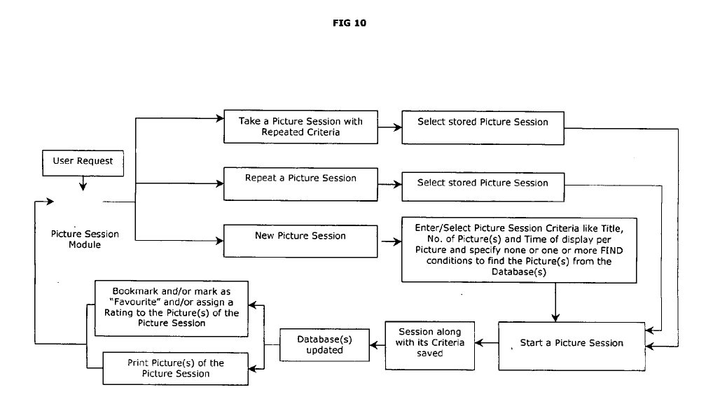

FIG. 14 describes the System Operation of Reports Module, explaining that the Module is based on user actions.

When the user enters this Module, the Control System brings forth a User Interface which displays a list of all the available types of Reports along with a brief description about each Report. The Reports Module allows the user to obtain the following Reports like
List of Pictures
Alphabetical Index of Pictures
Count of Pictures by Classification(s)
User Details
Picture usage report
Picture details report

The user then selects one of these Report types for printing. The Control System, depending on the type of Report selected, either brings forth a print preview of the Report from where the user can directly print the Report or brings forth a User Interface wherein the user must enter/select some Criteria beforehand and then the Control System brings forth the print preview of the Report by using Picture(s) found from the Database(s) by the Criteria specified by the user. The user comes out of the Module by closing either the print preview or the User Interface mentioned.

FIG. 15 describes the System State Transition of the Reports Module explaining that the Module is based on the different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 16 to 18 explain the System Function, System Operation and System State Transition respectively of the Export Module which provides the user with the utility of Exporting Pictures (by means of a Database file created by the System, or as Image file(s) or as MMS or using Email or using Network Messaging, or using the File Transfer Protocol (FTP)) stored in the Database(s), by finding the same from the Database(s) based on none or one or more FIND conditions,

FIG. 16 is the diagram of the System Function of Export Module of the present invention. The architecture of this Module comprises of the following major functions, which allow a user to Export Picture(s) stored in the Database(s), with the help of the User Interface.

The Module allows a user to:
Find existing Picture(s) from the Database(s) by none or one or more FIND conditions
Sort and Select Picture(s)
Validate Data
Export selected Picture(s) as Database File or as Image file(s) or as MMS or using Email or using Network Messaging, or using the File Transfer Protocol (FTP)

FIG. 17 describes the System Operation of Export Module, explaining that the Module is based on user actions.

When the user enters this Module, the Control System brings forth a User Interface which allows the user to choose whether or not to send flags like Bookmark, and/or ‘Favourite’, if any, along with the Picture(s) to be exported.—EXAMPLE—If the exporting user is exporting Picture(s) which have been Bookmarked, that user has an option of selecting whether or not to send the Bookmarks and associated Bookmark Remarks along with such Picture(s) to be exported. If the exporting user selects to send the Bookmarks and associated Bookmark Remarks, then the importing user is allowed to see that the Picture(s) have been bookmarked and can further view and modify the Bookmark Remarks associated with the bookmarked Picture(s). Else, the importing user cannot see that the Picture(s) have been bookmarked. The same applies in case the user wishes to send the ‘Favourite’ flag. The exporting user can choose to send either particular flag(s), all flags, or none of the flags with the Picture(s) to be exported. The user can also undo selections of the same. The flags that are chosen to be sent along with the Picture(s) to be exported are those set by the user who has currently logged in to the System. After the user has chosen whether or not to send the desired flags, the Control System brings forth a User Interface from where the user can find Picture(s) to be exported, from the Database(s) by none or one or more FIND conditions. The FIND conditions in this case are same as the ones described in FIG. 5. The Control System brings forth a User Interface, displaying the Find Results in a grid, and from where the user can Sort and Select the Picture(s) to be exported. The Sort and Select, including ‘Selected So Far’, functionalities in this case are same as the ones described in FIG. 5. The User Interface provides the user with the same utility(s)/functionality(s) applicable to Picture(s) in a Find Result grid as described in FIG. 5. The user can also view the details of the selected Picture(s) or those of the entire set of found Picture(s). If the user chooses to Export the selected Picture(s), the Control System performs a Data Validation. If the selected Picture(s) meet the Criteria of the Data Validation, the Control System allows these Picture(s) to be exported. Else, the Control System notifies the user that the Picture(s) cannot be exported.

After Data Validation, the Control System prompts the user as to whether the user wishes to export selected Picture(s) in the form of a Database file or as Image file(s), or as MMS or using Email or using Network Messaging, or using the File Transfer Protocol (FTP).

If the user chooses to export the selected Picture(s) in the form of a Database file, the Control System brings forth a User Interface from where the user must browse for and select the appropriate file/folder destination on the hard disk or any similar storage device on a computer system where the user wants to Export. After this selection, the user can Export the selected Picture(s) as a Database File. The Control System creates a Database file using the selected Picture(s) at the file/folder destination on a computer system as specified by the user and notifies the user that the selected Picture(s) were successfully exported and also displays the number of Picture(s) exported. The Control System adds the User Details of the exporting user to the Picture(s) in the Database file. These User Details can be viewed and further modified by the importing user through the User Interface showing the import Remarks, which is described in FIG. 20. After this, the Control System takes the user back to the User Interface from where the user can further Sort, Select, and Export Picture(s) in this manner. If the user closes this User Interface, the Control System gets notified and the user comes out from the Module.

If the user chooses to export the selected Picture(s) as Image file(s), the Control System brings forth a User Interface from where the user must browse for and select the appropriate file/folder destination on the hard disk or any similar storage device on a computer system where the user wants to Export. After this selection, the Control System exports the selected Picture(s) as separate Image file(s) in the file/folder destination specified by the user. The Control System also exports relevant details about the Picture(s) along with these Image file(s). These Image file(s) of the selected Picture(s) will be in the same file format as that in which the selected Picture(s) were created and/or stored by the user in the Picture Bank Module described in FIGS. 4 and 5. These file(s) can be further opened, viewed and/or modified using any external application. After this, the Control System takes the user back to the User Interface from where the user can further Sort, Select, and Export Picture(s) in this manner. If the user closes this User Interface, the Control System gets notified and the user comes out from the Module.

If the user chooses to export the selected Picture(s) as MMS or using Email or using Network Messaging or using the File Transfer Protocol (FTP), the Control System brings forth a User Interface wherein the user is required to enter and/or select relevant details. After the user has entered and/or selected relevant details and chooses to continue, the Control System exports the selected Picture(s) as MMS or using Email or using Network Messaging or using the File Transfer Protocol (FTP) depending on the details entered/selected by the user, notifies the user that the selected Picture(s) were successfully exported and also displays the number of Picture(s) exported. The Control System also sends relevant details about the Picture(s) along with the MMS or Email or the Network Message or using the File Transfer Protocol (FTP). The Control System saves the details entered and/or selected by the user in the User Interface for the purpose of future reference, and updates the Database(s) accordingly. After this, the Control System takes the user back to the User Interface from where the user can further Sort, Select, and Export Picture(s) in this manner. If the user closes this User Interface, the Control System gets notified and the user comes out from the Module.

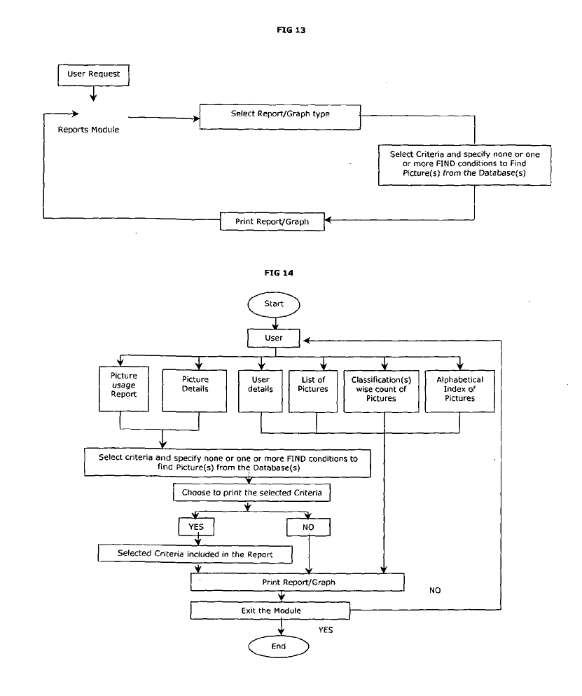

FIG. 18 describes the System State Transition of the Export Module explaining that the Module is based on the different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 19 to 21 explain the System Function, System Operation and System State Transition, respectively, of the Import Module which provides the user with the utility of Importing Picture(s) either from a Database file, that may have been created by other user(s) of this System, or from a media device, or as Image file(s), or using the File Transfer Protocol (FTP), with the utility of appending to the data already stored by the user in the Database(s).

FIG. 19 is the diagram of the System Function of Import Module of the present invention. The architecture of this Module comprises the following major functions, which allow a user to Import Picture(s) from a Database file that may have been created by other user(s) of this System or from a media device, or as Image file(s), or using the File Transfer Protocol (FTP) with the help of the User Interface.

The Module allows a user to:

Select to import Picture(s) either from a Database file created by other user(s) of this System, or from a media device, or as Image file(s), or using the File Transfer Protocol (FTP).

Browse for and select a Database file, or select a media device, or select a file/folder destination on the hard disk, or similar storage device on a computer system, or enter and/or select relevant FTP details.

Perform validation

Get Picture(s)

Sort and Select Picture(s)

Import Picture(s)

FIG. 20 describes the System Operation of Import Module, explaining that the Module is based on user actions.

When the user enters this Module, the Control System brings forth a User Interface from where the user must select to import Picture(s) either from a Database file created by other users of this System, or from a media device, or from Image file(s), or using the File Transfer Protocol (FTP).

If the user selects to import Picture(s) from a Database file created by other users of this System, the Control System brings forth a User Interface from where the user must browse for and select the appropriate Database file on a computer system from which the user wants to Import Picture(s). After this selection, the Control System verifies whether the file selected by the user is a valid Database file or not. If the file selected by the user is not a valid Database file, then the Control System notifies the user that the file is invalid and hence can't be imported. Else, the Control System brings forth a User Interface displaying all the Picture(s) in the Database file in a grid, and from where the user can further Sort and Select the Picture(s) to be imported. The Sort and Select functionalities are same as the ones described in FIG. 5. The user can select to import, the Picture(s) which the user has highlighted, the entire set of Picture(s) displayed in the grid facing the user, or the entire set of Picture(s) in the Database file. The user can also undo these selections. The user can further view the selected Picture(s) through a ‘Selected So Far’ utility, wherein the Control System brings forth a User Interface from where the user can view the selected Picture(s) as well as Sort and make further selections or undo selections of the same. If the user chooses to import the selected Picture(s), the Control System brings forth a User Interface from where the user can add/modify Import Remarks, and choose whether or not to import flags like Bookmark (and associated Bookmark Remarks) and/or “Favourite” along with the Picture(s). The flags have been set by the exporting user who has created the Database file by the export activity described in FIGS. 16 and 17. The data input field for Import Remarks in the User Interface, shows by default, the name of the exporting user and the date on which the Database file, which the user has selected to Import Picture(s), was created. This feature helps the user to keep track of the Pictures received from a particular exporting user, for the purpose of future reference. The user can further modify these Import Remarks and add more Import Remarks as desired. These Import Remarks can be seen and further modified through the Picture Bank Module described in FIGS. 4 and 5, into which the Picture(s) are imported. The user can also choose to import the selected Picture(s) without adding any Import Remarks. After the user has chosen to import the selected Picture(s), the Control System appends the Picture(s) to the Database(s). The Control System also imports relevant details about the selected Picture(s) which can be viewed by the user as Picture Properties in the Picture Bank Module described in FIGS. 4 and 5. After importing, the Control System updates the Database(s) and notifies the user that the selected Picture(s) were successfully imported and also displays the number of Picture(s) imported. After this, the Control System takes the user back to the User Interface from where the user can further Sort and Select Picture(s) to be imported. If the user closes this User Interface, the Control System gets notified and the user comes out from the Module.

If the user selects to import Picture(s) from a media device such as a scanner or a digital camera, the Control System brings forth a User Interface from where the user must browse for and select the appropriate media device attached to a computer system. After this selection, the Control System brings forth a User Interface which displays the Picture(s) stored in the selected media device in the form of thumbnails. The user can select any Picture(s) and choose to import the same. The Control System now executes a Validation process in order to check whether the selected Picture(s) to be imported are valid or not. If the Picture(s) selected by the user are not valid, then the Control System notifies the user that the Picture(s) can't be imported. Else, the Control System gets notified and brings forth a User Interface wherein the user is required to enter and/or select relevant Classifications and additional information for the selected Picture(s). After this, the Control System appends the Picture(s) to the Database(s) accordingly. The Control System also imports relevant details about the selected Picture(s) which can be viewed by the user as Picture Properties in the Picture Bank Module described in FIGS. 4 and 5. After importing, the Control System updates the Database(s) and notifies the user that the selected Picture(s) were successfully imported and also displays the number of Picture(s) imported. After this, the Control System takes the user back to the User Interface displaying the Picture(s) stored in the media device, from where the user can further select Picture(s) to be imported. If the user closes this User Interface, the Control System gets notified and the user comes out from the Module.

If the user selects to import Picture(s) as Image file(s), the Control System brings forth a User Interface from where the user must browse for and select the appropriate file/folder destination on the hard disk or any similar storage device on a computer system, from where the user wishes to import. After this selection, the Control System displays the Image file(s) in the selected file/folder destination from where the user can select the Image file(s) to import. After this selection, the Control System performs a Validation process in order to check whether the Image file(s) to be imported are valid or not. If the Image file(s) selected by the user are not valid, then the Control System notifies the user that the Image file(s) can't be imported. Else, the Control System gets notified and brings forth a User Interface wherein the user is prompted to enter and/or select relevant Classifications and additional information for the selected Picture(s). After this, the Control System appends the selected Image file(s) to the Database(s) accordingly. The Control System also imports relevant details about the selected Image file(s) which can be viewed by the user as Picture Properties in the Picture Bank Module described in FIGS. 4 and 5. After importing, the Control System updates the Database(s) and notifies the user that the selected Image file(s) were successfully imported and also displays the number of Image file(s) imported. After this, the Control System takes the user back to the User Interface displaying the Image file(s) stored in the hard disk or any similar storage device on a computer system, from where the user can further select Image file(s) to be imported. If the user closes this User Interface, the Control System gets notified and the user comes out from the Module.

If the user chooses to import Picture(s) using the File Transfer Protocol (FTP), the Control System brings forth a User Interface from where the user must enter and/or select relevant details. After the user has entered and/or selected relevant details and chooses to continue, the Control System brings forth a User Interface displaying Picture(s) which the user can select to import. After the user selects Picture(s), the Control System performs a Validation process to check whether the Picture(s) to be imported are valid or not. If the Picture(s) selected by the user are not valid, then the Control System notifies the user that the Picture(s) can't be imported. Else, the Control System gets notified and brings forth a User Interface wherein the user is required to enter and/or select relevant Classifications and additional information for the selected Picture(s). After this, the Control System imports the selected Picture(s) using the File Transfer Protocol (FTP), notifies the user that the selected Picture(s) were successfully imported and also displays the number of Picture(s) imported. The Control System also imports relevant details about the Picture(s) using the File Transfer Protocol (FTP), which can be further viewed by the user as Picture Properties in the Picture Bank Module described in FIGS. 4 and 5. The Control System also saves the details entered and/or selected by the user in the User Interface brought forth for importing Picture(s) using the File Transfer Protocol (FTP), for the purpose of future reference and updates the Database(s) accordingly. After this, the Control System takes the user back to the User Interface from where the user can further enter and/or select relevant details for the purpose of importing Picture(s) using the File Transfer Protocol (FTP). If the user closes this User Interface, the Control System gets notified and the user comes out from the Module.

The imported Picture(s) along with their Classifications and additional information can be viewed and further modified through the User Interface of the Picture Bank Module described in FIGS. 4 and 5.

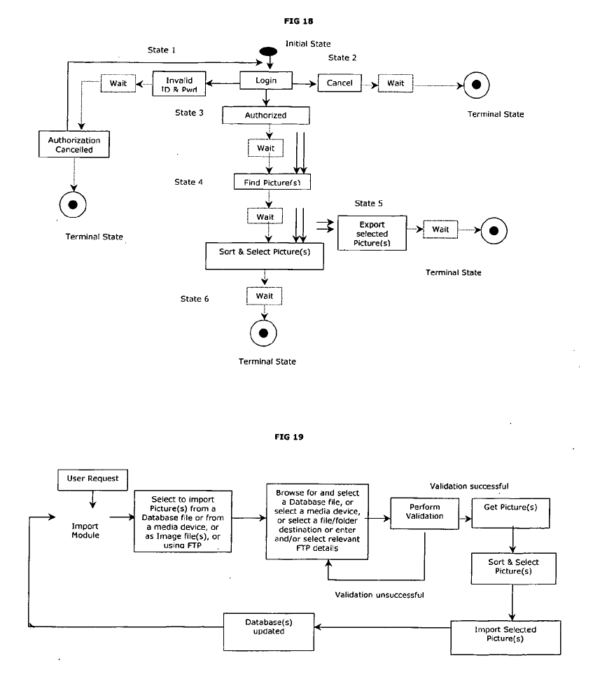

FIG. 21 describes the System State Transition of the Import Module explaining that the Module is based on the different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

FIGS. 22 to 24 explain the System Function, System Operation and System State Transition, respectively, of the Picture Scheduler Module which allows the user to Schedule Picture(s) to be displayed on the user's computer system at preset time intervals.

FIG. 22 is the diagram of the System Function of the Picture Scheduler Module of the present invention. The architecture of this Module comprises the following functions, which allow a user to find the Pictures from the Database(s) by none or one or more FIND conditions and Schedule them as desired with the help of a User Interface.

The Picture Scheduler Module, through a User Interface, causes the Control System to find and retrieve the relevant Picture(s) from the Database(s). The Module allows a user to:
Select the Module (e.g. Picture Bank Module, Picture Session Module)
Find existing Picture(s) from the Database(s) by none or one or more FIND conditions
Sort and Select the Picture(s)
Schedule time of Scheduled Session as well as time of display per Picture
Schedule Picture(s) as well as Schedule a Picture Session
Select to activate Background Music
Send Picture(s) as MMS and/or using Email and/or using Network Messaging and/or using the File Transfer Protocol (FTP) during the Scheduled Session

FIG. 23 describes the System Operation of the Picture Scheduler Module explaining that the Module is based on user actions.

The user has to first select the Module (Picture Bank Module, Picture Session Module) for the Pictures of which the user wants to Schedule at preset time intervals. The Control System brings forth a User Interface from where the user must find the Picture(s) from the Database(s) by specifying none or one or more FIND conditions. The FIND conditions in this case are same as the ones described in FIG. 5. The Control System brings forth a User Interface showing a grid which displays the Find Results from where the user can further Sort and Select the Picture(s). The Sort and Select functionalities are same as the ones described in FIG. 5. The User Interface provides the user with the same utility(s)/functionality(s) applicable to Picture(s) in a Find Result grid as described in FIG. 5. After the user chooses to Schedule the Picture(s), the Control System brings forth a User Interface from where the user must enter/select Criteria like Time of Scheduled Session, time of display per Picture, and choose between scheduling the Picture(s) as it is or scheduling the Picture(s) as an Picture Session. The user can also select to listen to a Background Music Sound File during the Scheduled Session. The Control System schedules the Picture(s) accordingly. The user then closes the User Interface and comes out of the Module. The scheduled Picture(s) are displayed at the specified time, according to the user's selection. The user can also send the Picture(s) as MMS and/or using Email and/or using Network Messaging and/or using the File Transfer Protocol (FTP) during the Scheduled Session in the same manner as described in FIGS. 16 and 17. The Control System saves the Scheduled Session, generates a new Scheduled Session Id, and updates the Database(s) accordingly.

Note: The user can decide whether the Scheduler should remain active in the System tray of the user's computer system irrespective of whether the System is running or not.

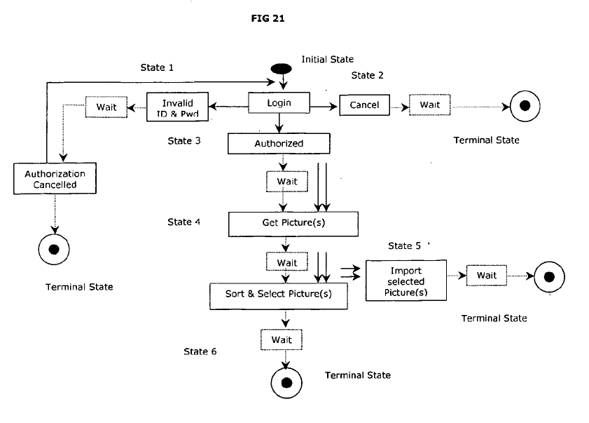

FIG. 24 describes the System State Transition of the Picture Scheduler Module explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

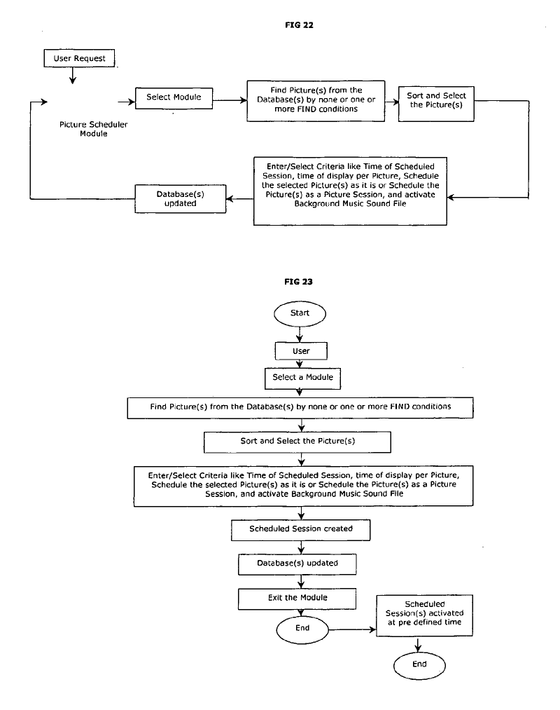

FIGS. 25 to 27 explain the System Function, System Operation and System State Transition respectively, of the Screen Saver Module which allows the user to use the Pictures stored in the Database(s) as a Screen Saver.

FIG. 25 is the diagram of the System Function of Screen Saver Module of the present invention. The architecture of this Module comprises of the following major functions, which allow a user to use the Picture(s) stored in the Database(s) as a Screen Saver.

The Module allows a user to:
Select the Module for the Picture(s) of which the user wants to use as a Screen Saver (e.g. Picture Bank Module, Picture Session Module)
Enter time after which the Screen Saver is to be activated
Enter the time interval for which Picture(s) appear as a Screen Saver
Select to listen to Background Music along with the Screen Saver

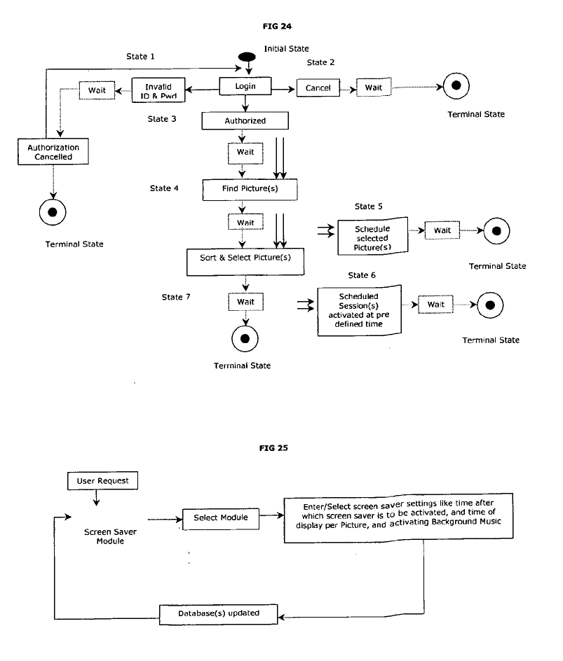

FIG. 26 describes the System Operation of the Screen Saver Module of the System explaining that the Module is based on user actions.

The user first selects the Module for the Picture(s) of which the user wants to use as a Screen Saver. The Control System brings forth a User Interface from where the user can set Screen Saver settings like entering the time after which the Screen Saver is to be activated, entering the time interval for which Picture(s) appear as a Screen Saver, and selecting to listen to Background Music along with the Screen Saver. In case, the user selects to listen to Background Music along with the Screen Saver, the user must further browse for and select the desired Sound file from a computer system, for the same. The user can also clear all entries/selections on the User Interface for new data input. After the user makes the necessary entries/selections and chooses to save the same, the Control System saves the Screen Saver settings and updates the Database(s) accordingly. The Screen Saver is activated if the user's computer system is left unused for a time as may be specified by the user in the Screen Saver settings. The Picture(s) which appear as a Screen Saver are randomly selected from the Database(s) by the Control System. The user can also select Pictures to appear as a Screen Saver. The user can further modify the Screen Saver settings as and when required.

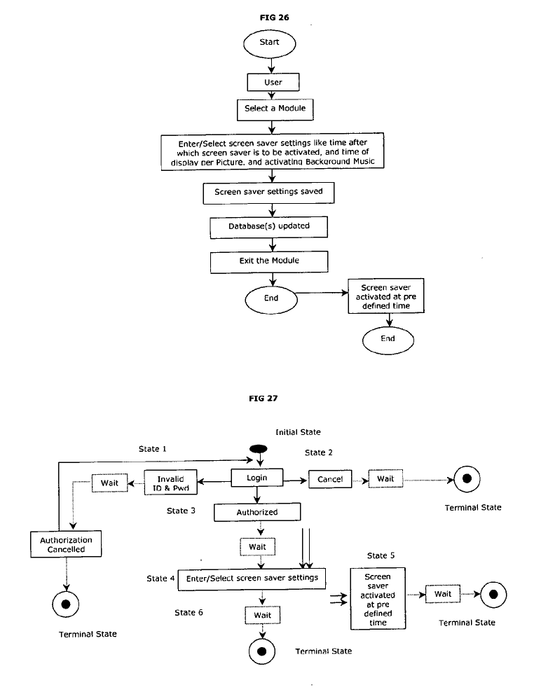

FIG. 27 describes the System State Transition of the Screen Saver Module of the present invention explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

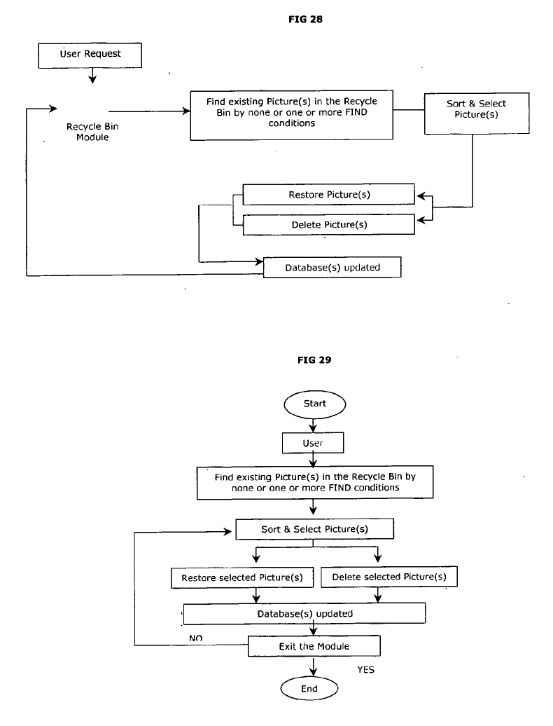

FIGS. 28 to 30 explain the System Function, System Operation and System State Transition respectively, of the Recycle Bin Module which allows the user to Restore or Permanently Delete Picture(s), which may have been deleted by the user.

FIG. 28 is the diagram of the System Function of Recycle Bin Module of the present invention. The architecture of this Module comprises of the following major functions, which allow a user to Restore/Permanently Delete Picture(s) with the help of the User Interface.

The Module allows a user to:
Find existing Picture(s) in the Recycle Bin of the System, by none or one or more FIND conditions
Sort and Select Picture(s)
Restore/permanently Delete selected Picture(s)

FIG. 29 describes the System Operation of the Recycle Bin Module of the present invention explaining that the Module is based on user actions.

When the user first enters this Module, the Control System brings forth a User Interface which allows the user to find the Picture(s) that have been deleted earlier and are lying in the Recycle Bin of the System, by none or one or more FIND conditions. The FIND conditions in this case are the same as the ones described in FIG. 5. The Control System brings forth a User Interface displaying the Find Results showing the Picture(s) which have been deleted by the user, in a grid, and from where the user can further Sort and Select the Picture(s) to be Restored or permanently Deleted. The Sort and Select, including ‘Selected So Far’, functionalities in this case are same as the ones described in FIG. 5. The user can also view the details of the selected Picture(s) or those of the entire set of found Picture(s). The user can also print the selected Picture(s). After the user selects the Picture(s), the user can choose to either Restore or permanently Delete the Picture(s). In both cases, the Control System prompts the user as to whether or not the user wants to Restore or permanently Delete the selected Picture(s). If the user chooses to Restore the selected Picture(s), the Control System takes the selected Picture(s) out of the Recycle Bin and restores them back to their respective Module with their original Picture Id(s). If the user chooses to permanently Delete the selected Picture(s), the Control System deletes the selected Picture(s) from the Recycle Bin and thus permanently removes the Picture(s) from the Database(s). Sufficient care is exercised by the Control System to ensure that Picture(s) that are in use, in existing Picture Session(s) and/or Scheduled Session(s), are not permanently deleted.—EXAMPLE—If certain Picture(s) in the Recycle Bin are in use in existing Picture Session(s) and/or Scheduled Session(s) and if the user chooses to Delete them, then the Control System notifies the user that the Picture(s) are in use, and hence cannot be permanently deleted.

Whenever Picture(s) are Restored or Deleted, the Control System updates the Database(s) and notifies the user that the selected Picture(s) were successfully Restored or Deleted and also displays the number of Picture(s) Restored or Deleted. After this, the Control System takes the user back to the User Interface from where the user can further Sort and Select Picture(s) to be Restored or Deleted. This User Interface further allows the user to print and/or Export the selected Picture(s) displayed in the grid in the same manner as described in FIG. 5. If the user closes this User Interface, the Control System gets notified and the user comes out from the Module.

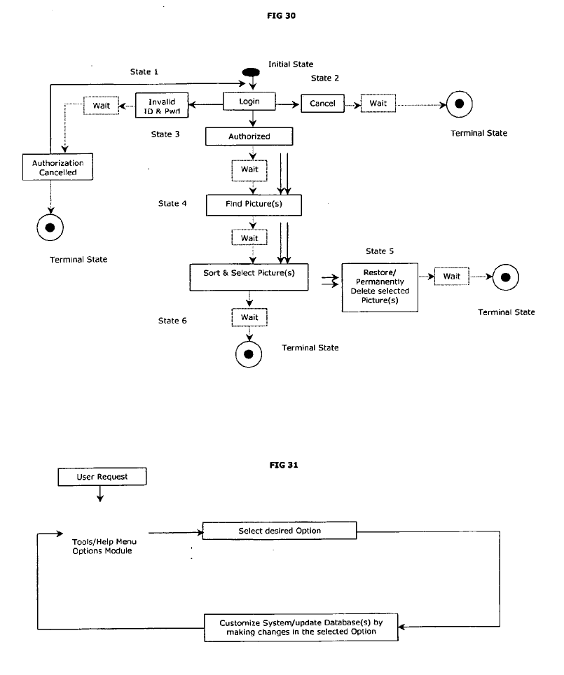

FIG. 30 describes the System State Transition of the Recycle Bin Module of the System explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

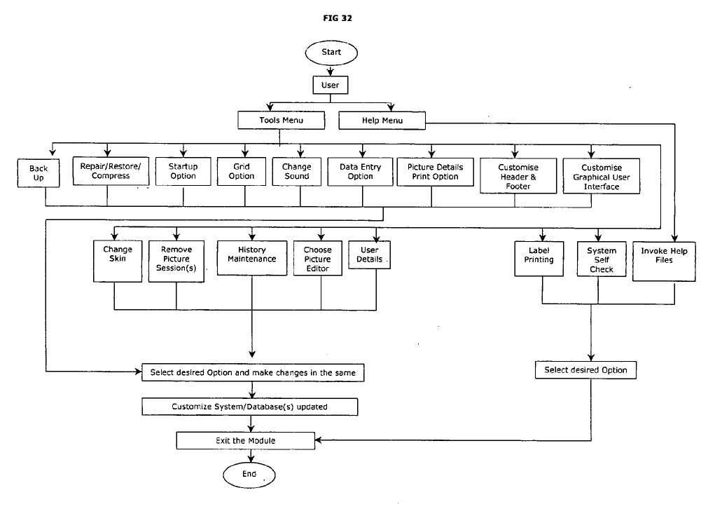

FIGS. 31 to 33 explain the System Function, System Operation and System State Transition respectively, of the Tools/Help Menu Options Module comprising of maintenance Tools such as Back Up, Repair, Restore, Compression of the entire Database(s) and System Self Check. There are other tools such as Start Up Option, Grid Option, Change Sound, Data Entry Option, Label Printing, Picture Details Print Option, Customize Header and Footer, Customize Graphical User Interface, Change Skin, Remove Picture Session(s), History Maintenance, Choose Picture Editor, User Details, and Help.

FIG. 31 is the diagram of the System Function of Tools/Help Menu Options Module of the present invention. The architecture of this Module comprises of the following major functions, which allow a user to select any option for Customization including maintenance of the System and updating of Database(s).

The Module allows a user to:
Select any option
Customize the System/Update Database(s) by making changes in the selected option.

FIG. 32 describes the System Operation of the Tools/Help Menu Options Module, explaining that the Module is based on user actions. Through this Module, the user can select any of the options mentioned below for customization and maintenance of the System.

The Tools/Help Menu Options Module, through the User Interface, retrieves and brings forth the following utilities which the user can select:
Back Up—This utility allows the user to back up the Database(s). If the user selects this utility, the Control System brings forth a User Interface from where the user must browse for and select the appropriate file/folder destination on the user's computer system, where the user wants to take the backup. The Control System backs up the entire Database(s) and creates a backup at the selected file/folder destination.
Restore—This utility allows the user to restore the Database(s) from a backup taken by the user by using the Back Up utility. If the user selects this utility, the Control System brings forth a User Interface from where the user must browse for and select the appropriate file/folder destination on the user's computer system, where the user has taken the backup. The Control System restores the Database(s) with the backup accordingly.
Repair and Compress—This utility allows the user to repair and compress the Database(s).
System Self Check—This utility allows the user to initiate a System Self Check. If the user selects this utility, the Control System gets notified and initiates a System Self Check. The Control System notifies the user whether the System Self Check has completed successfully or not, and further generates a Report displaying the tasks performed during the System Self Check.
Start Up Option—This utility allows the user to set conditions like the Login User Interface and Quick Start User Interface to appear each time the System is initiated. If the user selects this utility, the Control System allows the user to select either or both the Login and the Quick Start User Interfaces to appear each time the System is initiated. The Control System updates the Database(s) in this case.
Grid Option—This utility allows the user to enter the number of Picture(s) to be displayed in a Find Result grid at a time, facing the user.—EXAMPLE—If the user enters 24, then 24 Picture(s) will be displayed in any Find Result grid at a time, facing the user. This utility further allows the user to choose whether or not the Control System should remember the current FIND criteria entered and/or selected by the user when the user chooses to find Picture(s) from the Database(s). The Control System updates the Database(s) in this case.
Change Sound—This utility allows the user to change sounds like the background sounds which are used in an Picture Session(s) and/or Scheduled Session(s). If the user selects this utility, the Control System brings forth a User Interface which displays the sound files for background sounds selected by the user, and further allowing the user to browse for and select the appropriate sound files for background sounds. The user can further play the sound files thus selected by the user for the background sounds. The user can also select the sound files specified as default for background sounds. The Control System updates the Database(s) in this case.
Data Entry Option—This utility allows the user to enable/disable the “Copy Current Entry” functionality during data input, as well as allowing further customization of the same. The “Copy Current Entry” functionality is described in FIG. 5. If the user selects this utility, the Control System brings forth a User Interface, from where the user must first select whether to have “Copy Current Entry” functionality during data input or not, as well as select the data input fields to be copied using this functionality. The Control System updates the Database(s) in this case.
Label Printing—This utility allows the user to print user information labels.
Picture Details Print Option—This utility allows the user to customize the Criteria for printing Details of a Picture. If the user selects this utility, the Control System brings forth a User Interface from where the user can select the part(s) of a Picture that are to be printed. The user can also undo all of these selections. The Control System updates the Database(s) in this case.
Customize Header and Footer—This utility allows the user to customize the Header and Footer for the Printed outputs. If the user selects this utility, the Control System brings forth a User Interface from where the user can enter the appropriate Header and Footer details which will appear in all the Reports. The Control System updates the Database(s) in this case.
Customize Graphical User Interface—This utility allows the user to change the Labels that appear on the User Interface. The Control System updates the Database(s) in this case.
Change Skin—This utility allows the user to select the “skins” for the User Interface. If the user selects this utility, the Control System brings forth a User Interface from where the user can browse for and select the desired “skin” file. The user can also set a “skin” file as the default “skin”. The user can also undo these selections. The Control System updates the Database(s) in this case.
Remove Picture Session(s)—This utility allows the user to permanently remove previously taken Picture Sessions, such deletions capable of being made selectively. If the user selects this utility, the Control System brings forth a User Interface showing a grid which displays all Picture Session(s) taken earlier. The user can Sort the Picture Session(s), in ascending or descending order, by various Classifications. The user can further select all or specific Picture Session(s) from the grid, to be removed from the System. If the user chooses to remove the selected Picture Session(s), then the Control System prompts the user as to whether or not the user wants to remove the selected Picture Session(s). If the user chooses to continue, the Control System removes the selected Picture Session(s) from the System and notifies the user about the same. The Control System updates the Database(s) accordingly.
History Maintenance—This utility allows the user to delete the History for a certain Picture in the Database(s). The Control System maintains a History of each Picture in the Database(s) in terms of Criteria such as its Picture Id, the user who has created and/or stored it, whether or not the Picture has appeared in a Picture Session and/or a Scheduled Session, the frequency by which the Picture appeared in the same, Date and time of the same. The Control System updates the Database(s) in case the user deletes the History of Picture(s).
Choose Picture Editor—This utility allows the user to choose any application (if any) installed on the user's computer system for the purpose of creating, modifying, and storing Pictures in the Picture Bank Module described in FIGS. 4 and 5. The Control System updates the Database(s) accordingly.
User Details—This utility allows the user to enter or modify the user details like User Name and Password. The user can also create Sub users through this option. The Control System updates the Database(s) accordingly.
Help—This utility allows the user to invoke the Help files, which provide Help on how best to use the System.

After selecting any of the options mentioned above and customising or using the same, the user comes out of the Module.

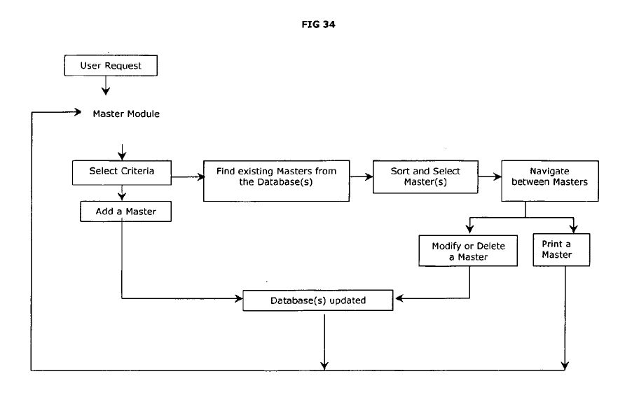

FIG. 33 describes the System State Transition of the Tools/Help Menu Options Module explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

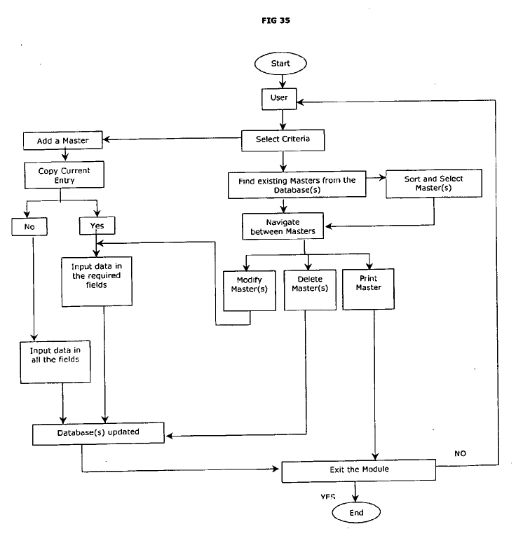

FIGS. 34 to 36 explain the System Function, System Operation and System State Transition respectively, of the Master Module which provides the utility of creating, editing, deleting, printing, navigating, finding Masters like: User, Source of Information, Type of Picture, Creator of Picture, Category and Sub Category. Sufficient security is provided by the System, so as not to allow the deletion of any Master of a Picture that may be in use.

FIG. 34 is the diagram of the System Function of the Master Module of the present invention. The architecture of this Module comprises of the following major functions, which allow a user to create and store Masters for Criteria with the help of the User Interface.

The Module allows a user to:
Select Criteria
Add Master(s) for the selected Criteria
Copy Current Entry
Find existing Master(s) from the Database(s)
Sort and Select Master(s)
Modify Master(s)
Delete Master(s)
Go To a Master and Navigate between Masters
Print Master(s)

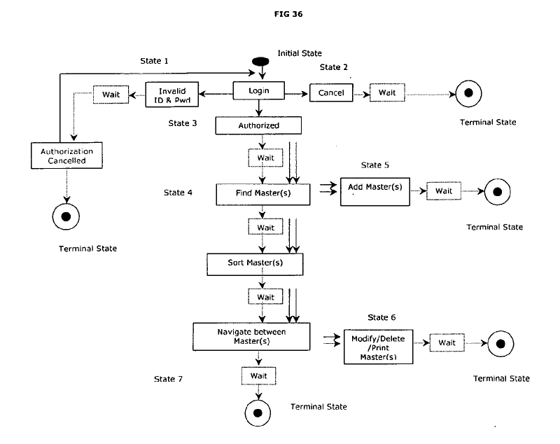

FIG. 35 describes the System Operation of the Master Module explaining that the Module is based on user actions. The Master Module accepts data capable of being accepted from more than one user at the same time.

The user first selects the desired Criteria like User, Source of Information, Type of Picture, Creator of Picture, Category and Sub Category for which the user wishes to create, find, modify, delete, and print Masters. The Control System brings forth a User Interface from where the user can Create Master(s), Find Master(s), Modify Master(s), Delete Master(s), Navigate between Master(s), Print Master(s), for the Criteria selected by the user. All of these functionalities are described below in detail.

The Create Master functionality allows the user to create a Master for the selected Criteria by allowing data input in the fields provided for the purpose in the User Interface described above. When the user chooses to create a Master, the Control System prompts the user as to whether or not the user wishes to copy the current Master, if any, facing the user. If a user chooses not to use this “Copy Current Entry” utility, then the Control System gets notified and blanks out the relevant data input field(s) for new data input by the user. The user can then enter data in the relevant data input field(s) as desired. After the user creates a new Master and chooses to save it, the Control System checks whether the new Master created by the user is a duplication of any Master created earlier. If the created Master is a duplication, then the Control System notifies the user that the user cannot create duplicate Masters and does not allow the user to save the Master. Else, the Control System saves the Master and updates the Database(s). The user can now use this Master for the selected Criteria at the time of creating, storing, or modifying Picture(s) in any data input Module like the Picture Bank Module. The user can also create Masters by entering the same in the relevant data input fields when the user is adding or modifying Picture(s) in any data input Module. The Masters thus created are also visible to the user through the Master Module.—EXAMPLE—If the user creates Masters through the Master Module for the Criteria of Category and Sub Category as CATEGORY>ANNIVERSARIES>SUB CATEGORY>WEDDING ANNIVERSARY, then the Masters like ANNIVERSARIES, and WEDDING ANNIVERSARY for Category and Sub Category are available to the user, when the user is creating, storing, or modifying a Picture in any data input Module. Conversely, if the user creates Masters like the ones described above for Category and Sub Category by entering the same in the relevant data input fields when creating, storing, or modifying a Picture in any of the data input Modules, then these Masters would be visible to the user in the Master Module. The Control System also updates the Database(s) in this case. If the user imports a Picture into any data input Module, the Masters contained in the Picture will also be visible to the user through the Master Module. The Control System also updates the Database(s) in this case. The Control System generates a new Master Id each time a new Master is created and saved by the user in either of the ways described above or when a Picture is imported by the user which contains relevant Masters for Criteria like User, Source of Information, Type of Picture, Creator of Picture, Category and Sub Category. The Find functionality allows the user to find existing Master(s) stored in the Database(s). If the user chooses to use this functionality, then the Control System brings forth a User Interface from where the user can find Master(s) by entering keywords.—EXAMPLE—If there is a Master ‘PHOTOGRAPH’ for the Criteria of Type of Picture stored in the Database(s) and the user types in just ‘PH’, then the ‘PHOTOGRAPH’ Master will appear in the Find Results. The same applies in case the user enters any part of the word ‘PHOTOGRAPH’ as a keyword. If the user does not enter any keyword and chooses to Find Master(s), then the Control System brings forth Find Results showing all the Master(s) stored in the Database(s) for the selected Criteria. If a keyword entered by the user is not there in any of the Master(s), then the Control System notifies the user that no Master(s) have been found for the keyword entered by the user. The Control System brings forth a User Interface displaying the Find Results in a grid, from where the user can further Sort and group, the Masters currently displayed in the Find Result grid facing the user or the entire set of found Masters.

The Modify functionality allows the user to Modify a Master stored in the Database(s). If the user chooses to use this functionality then the user can use all the utility(s)/functionality(s) available at the time of creating a Master. After modification, if the user chooses to save the modification done to the Master, the Control System saves the same accordingly and updates the Database(s). Else, the modifications made by the user to the Master will not be saved. The modifications made by the user to the Master will be reflected in all the Picture(s) which use that Master, in any data input Module and/or in any Picture Session(s) and/or Scheduled Session(s).

The Delete functionality allows the user to Delete an existing Master stored in the Database(s). If the user chooses to use this functionality, the Control System prompts the user as to whether or not the user wishes to Delete that particular Master. If the user chooses to delete the Master, the Control System deletes the Master permanently from the System. The Control System updates the Database(s) in this case. However, if the Master to be deleted is being used by any Picture in any data input Module and/or in any Picture Session(s) and/or Scheduled Session(s), the Control System notifies the user that the Master is in use and hence cannot be deleted.

The Navigation functionality allows the user to navigate between the Masters stored in the Database(s).

The Printing functionality allows the user to print Master(s) stored in the Database(s).

If the user closes the User Interface described above, the Control System gets notified and the user comes out from the Module.

FIG. 36 describes the System State Transition of the Master Module explaining that the Module is based on different States. The Control System receives events from the user(s), and each event causes the transition from one State to another within the Module.

Each State contains its own separate Terminal State. A double lined transition arrow from State 4 indicates that multiple instances of the State are possible. So it is possible for multiple instances of State 4 to occur, each of which has its own Terminal State. A transition shown with a dotted line indicates that it is leaving from one State and entering another State.

Thus, while there have been shown and described and pointed out fundamental novel features of the present invention as applied to preferred embodiments thereof, it will be understood that the described embodiments are to be considered in all respects only as illustrative and not restrictive and various omissions, substitutions and changes in the form and details of the methods described may be made by those skilled in the art without departing from the spirit of the present invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is the intention, therefore, to be limited only as indicated by the scope of the claims appended hereto. All changes which come within the meaning and range of equivalency of the claims are to be embraced within their scope.

### Technical Application to Industry:—

The invention has several technical applications for the photography, art, and security industries. The invention has the potential to change the way in which Pictures are created, stored, modified and shared in the such industries.
1) The invention allows users to build a personalized and well-classified databank of Pictures, with the possibility of additional information being stored. This would be useful for professional artists and photographers who can create and/or store Pictures based on a particular category or a topic. Further, it would help people to store selected Pictures according to their personal requirements. It would be of immense use to companies which create, store, and maintain Picture libraries for commercial purposes, in that they would be able to create, store, and maintain a repository of Pictures in a well-classified manner.
2) The invention allows users to constantly modify and update data as per their requirement, with a minimum amount of effort. This would be a very helpful and time-saving utility, for professional artists and photographers, who often review and edit their work several times. Further, this utility would help persons and organizations working in the intelligence and security industry to maintain updated profiles of important persons, objects, places, and such others. This would also be of immense use to companies which create, store, and maintain Picture libraries for commercial purposes, in that they would be able to modify and update their repositories of Pictures quickly and easily.
3) The invention facilitates ease of retrieval of data from the databank, using a powerful Find utility that allows users to quickly search through a large database for specific data. Since the information is well classified, and available in one container, it eliminates the necessity of having to create and sort through many files and/or documents, thus reducing the time spent on such an activity. This utility is particularly useful for companies which create, store, and maintain Picture libraries for commercial purposes, wherein the Picture library may contain millions of Pictures, and as such finding them becomes a tedious process.
4) The invention also facilitates the sharing of data, through an Export/import module. This utility can encourage the exchange of data between different persons, organizations, or institutions, regardless of their physical location, thus helping create a larger common repository of data for a wider audience.
5) The invention has a provision for safeguarding confidential/proprietary content and prevents accidental deletion of the same. This would be particularly useful in the security industry wherein people come across such content on a daily basis. invention has many other useful features, such as allowing users to attach and associate audio-visual files in order to create more comprehensive data. The invention is also capable of distributing information through various mass media.

### Mass-Media and the Invention:

The use of the invention to the publishing industry can be optimized by exploring the potential of mass media. This can be seen as follows: —
1) Publishing/Printing of Picture Books/Albums: The invention could be used by publishers, for printing and/or publishing Picture books/albums. Moreover, since the invention allows a detailed classification of data, Pictures based on a particular category or topic can be published with ease, for example, “Family Photographs”.
2) The Internet: The invention can be used to create a repository of Pictures to be used by all kinds of websites, either general in nature or focusing specifically on Pictures. In addition, it can also be used to send and receive Pictures using E-mail and/or using Network Messaging and/or using the File Transfer Protocol (FTP).
3) Mobile Services: The invention can be used to create a repository of Pictures which can be offered through Value Added Services, by mobile service operators. The popularity of MMS would ensure a large audience for such Pictures, thus adding another dimension to these services.

What is claimed is:

1. An interactive system for building, organizing, and sharing one's own databank of pictures including photographs, drawings, art, sketch, iconography, illustrations, portraits, paintings, and images, in one or more languages, using a computer system, said interactive system comprising:
i) a user interface;
ii) one or more well-classified databases to store data user wise including a picture bank database, a user database, and a configuration database;
iii) at least one well classified picture bank module to input, organize and manage one's own databank of pictures in the form of data/record(s) in the databases;
iv) modules for sharing, invoking, customizing the pictures data in the form of data/record(s) in the databank, for gaining information and/or for entertainment/enjoyment of photographs, drawings, art, sketch, iconography, illustrations, portraits, paintings, and images; and
v) a control system acting as a bridge between the modules and the databases to display relevant data/record(s) on the user interface by finding the same from the databank, based on none or one or more “FIND” conditions.

2. The system according to claim 1 wherein the “FIND” conditions to find the data/record(s) from the databank are defined by none or one or more classifications comprising Date, Record ID, Source of Information, Type of Picture, Creator of Picture, Category and Sub Category, including classifications of keywords, wildcard characters, by whether or not a picture has file attachments/Associations and/or attachment/association remarks, import remarks, and/or whether or not a picture has been bookmarked and further by bookmark remarks, and/or whether or not a picture is marked as “Private” or “Public” and/or “Favorite” as well as assigned a rating, and/or by whether or not a picture has been used in a picture/scheduled session and if so, the number of times it has been used.

3. The system according to claim 1 wherein the said picture bank module allows the user to classify the data/record(s) by classifications selected or added in one or more groups comprising Date, Record ID, Source of Information, Type of Picture, Creator of Picture, Category and Sub Category.

4. The system according to claim 1 wherein said picture bank module allows the user to store additional information about a picture including camera used, location, name of photographer/artist, and remarks.

5. The system according to claim 1 wherein said picture bank module allows the user to find data/record(s) from the databank, which have similar classifications.

6. The system according to claim 1 wherein said picture bank module comprises a utility for copying of existing classification and previously entered data/record(s) for new data/record input by the user, for ease of data entry, with a choice of defining an extent of details to be copied.

7. The system according to claim 1 wherein the modules include a picture session module, which allows the user to invoke and store a picture session for gaining information and/or for entertainment or enjoyment of pictures including photographs, drawings, art, sketches, iconography, illustrations, portraits, paintings, and images, using the data/record(s) from the databank, such data/record(s) having been selected by the user by finding the same from the databank, based on none or one or more “FIND” conditions.

8. The system according to claim 1 wherein the modules include a picture session module, which allows the user to schedule the data/record(s) by finding the same from the databank by none or one or more “FIND” conditions, and said pictures are brought up on the user's computer system at preset time intervals.

9. The system according to claim 1 wherein the modules include a screen saver module, which allows the user to display the data/record(s) in the databank as screen savers.

10. The system according to claim 1 wherein the modules include an export module, which allows the user to export data/record(s) from the databank, such data/record(s) having been selected by the user by finding the same by none or one or more FIND conditions.

11. The system according to claim 1 wherein the modules include an import module, which allows the user to import data/record(s), built by another user using the same system.

12. The system according to claim 11 wherein the import module further comprises a utility, which allows the user to selectively import the data/record(s).

13. The system according to claim 1 wherein the modules include a global changes module, which allows the user to modify data/record(s), delete data/record(s), bookmark data/record(s), mark data/record(s) as “Public” or “Private” and/or “Favorite”, assign a rating, associate additional information in the form of file(s)/URL(s)/remark(s) to data/record(s), attach a file including an image, animation, or a sound file to data/record(s), individually as well as globally.

14. The system according to claim 1 wherein the modules include a recycle bin module, which allows the user to restore or permanently remove data/record(s) individually or plurally from the databank.

15. The system according to claim 1 wherein the modules include a reports module, which allows the user to print reports and/or graphs from the data/record(s) in the databank, by none or one or more “FIND” conditions.

16. The system according to claim 1 wherein the modules include a tools/help menu options module which allows the user to select an option for customization including system maintenance and updating of databases.

17. The system according to claim 1 wherein the modules include a master module, which allows the user to create and store masters for well-defined classifications.

18. The system according to claim 1 wherein the modules and utilities are adapted to be operated within a browser and/or other viewing and/or processing programs and to operate on one or more computer systems including hand held devices.

19. An interactive system for building, organizing, and sharing one's own databank of pictures including photographs, drawings, art, sketch, iconography, illustrations, portraits, paintings, and images, in one or more languages, using a computer system, said interactive system comprising:
i) a user interface;
ii) one or more well-classified databases to store data/record(s) user wise including a picture bank database, a user database, and a configuration database;
iii) at least one well classified picture bank module to input, organize and manage one's own databank of pictures in the form of data/record(s) in the databases for classifying the data/record(s) by classifications selected or added in one or more groups comprising Date, Record ID, Source of Information, Type of Picture, Creator of Picture, Category and Sub Category; and
iv) a control system acting as a bridge between the module and the databases to display relevant data/record(s) on the user interface by finding the same from the databank, based on none or one or more “FIND” conditions.

20. The interactive system according to claim 19 wherein the picture bank module includes a utility for copying of existing classification and previously entered data/record(s) for new data input by the user, for ease of data/record entry, with a choice of defining an extent of details to be copied.

21. The system according to claim 19 wherein the picture bank module allows the user to modify a record/data individually and further comprises of a utility, which allows the user to modify data/record(s) globally.
